(19) United States
(12) Patent Application Publication
(10) Pub. No.: US 2007/0226793 A1
(43) Pub. Date: Sep. 27, 2007

(54) Parent-Child Card Authentication System

(75) Inventors: Masamoto Tanabiki, Kanagawa (JP); Hayashi Ito, Chiba (JP); Emi Tsurukiri, Tokyo (JP); Yasuo Takeuchi, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/569,612

(22) PCT Filed: May 24, 2005
(86) PCT No.: PCT/JP05/09436

§ 371 Date: Nov. 27, 2006

(30) Foreign Application Priority Data
May 28, 2004 (JP) 2004-158745
Jul. 28, 2004 (JP) 2004-219519

(51) Int. Cl. H04L 9/32

(52) U.S. Cl. 726/21

(57) ABSTRACT

When a special relationship is present between IC card owners, authority of one of the IC card owners cannot be easily given to the other owner of the IC card. However, an IC card of a second owner can issue a public key certificate of the IC card of a first owner so that the IC card of the first owner can be recognized as a child card of the IC card of the second owner. Thus, the first generation card authenticated by a route authentication station is set as an ancestor which can generate a descendent card which receives the authentication. By checking which parent card has issued the public key authentication owned by the child card, it is possible to given the authority of the parent card to the child card.

### BACKGROUND OF THE INVENTION

1. Field of the Invention

The present invention relates to the authentication of a memory device such as an IC card, which can be configured to have a parent-child relationship.

2. Description of the Related Art

The memory device such as an IC card (refer to Japanese Patent Publication No. 2004-104539) is capable of storing larger amounts of information in comparison with a magnetic card, and is able to be equipped with a processing ability for encryption etc. by comprising die internal CPU, so that it becomes attractive. For example, a memory device such as an IC card is used in commuter passes for trains etc. used at automatic ticket wickets (refer to Japanese Patent Publication No. 2004-102880), or is starting to be used as a medium for electronic money at convenience stores etc.

The following two steps are required for the practical use of IC cards in actual commerce etc. (1) the step of authentication by the certificate authority, and (2) the step of issuance processing by the card issuer (refer to Japanese Patent Publication No. 2003-16397). In (1) the step of authentication by the certificate authority, the certificate of the public key corresponding to the secret key of the IC card (hereinafter, referred to as ‘public key certificate’) is issued by the certificate authority. The public key certificate, called the digital certificate in some cases, is information including a public key, and a signature by a secret key of the certificate authority corresponding to the public key. By means of the public key certificate, it becomes possible to prevent falsification of the public key, and from falsification of the IC card by a malicious party, In (2) the step of issuance processing by die card issuer, the information of the IC card holder is applied to the card issuer, and the credit examination is executed, so that the data and the application necessary for the IC card are stored. Note that, in Japanese Patent Publication No. 2003-16397, the technology, in which the child card is enabled under the management by the parent card, is disclosed. In this case, as described in the paragraph 172 of Japanese Patent Publication No. 2003-16397, the child card is issued by means of the data, which is different from the data used for authentication by the certificate authority.

FIG. 1 is a diagram exemplifying of hierarchical structure constructed by the certificate authority and the end entities such as IC cards. In this hierarchical structure, the root is indicated at the top of tree structure, and branches head downward. The initial certificate authority (CA) is positioned at the root, the certificate authority authenticated by the initial certificate authority is positioned in the second class, and the certificate authority in the second class authenticates the certificate authority in the third class. The certificate authority is positioned in the tier 101, which does not correspond to the leaf. The end-entity (e.g., IC card), which is not the certificate authority, is positioned in the tier 102, which corresponds to the leaf/

FIG. 2 is a flow chart of the issuance process of the IC card by the card issuer. At the outset, the user's information, the information of the IC card holder, is applied to the card issuer (step S201). The credit examination is executed based on the application (step S202). If issuance of card is allowed, the card is issued (step S204). For example, the necessary data is stored by the IC card.

In this case, although the authentication and the issuance are described as different steps, in many cases, after the card issuer requests the issuance of public key certificate of the IC card to the certificate authority, the card issuance process is carried out, and the public key certificate and the data of the card are stored at the same time. Consequently, it is rare that the IC card holder regards the above steps as two different steps.

Further, the IC card has some states, and these states are called as ‘life cycle’. Therefore, the IC card has the following states, ‘initial state’, a state that the IC card is manufactured in a factory etc., ‘issued state’, a state that the card is issued by the card issuer, ‘temporarily disabled state’, a state that the card is disabled for some reason in commerce etc., ‘expired state’, a state that the card is expired, and ‘invalid state’, a state that the card is invalid (refer to Japanese Patent Publication No. 2004-030240).

In addition, since the IC card is capable of storing large amounts of information, if it is lost, the potential damage is huge, so that the technology for issuing another IC card as a child card is used, For example, in Japanese Patent Publication No. 2003-016397, the technology, in which the child card is enabled under the management of the parent card, is disclosed.
The cited document 1: Japanese Patent Publication No. 2004-104539
The cited document 2: Japanese Patent Publication No. 2004-102880
The cited document 3: Japanese Patent Publication No. 2003-16397
The cited document 4: Japanese Patent Publication No. 2004-030240
The cited document 5: Japanese Patent Publication No. 2003-016397

Thus, the application and the examination for user's information are necessary for the IC card issuance process. However, there are cases where the IC card holder can believe another IC card holder, for example, husband and wife. In this case, when the IC card holder provides all or part of the authority with another IC card holder, the application and the examination for another IC card holder's information are necessary, thereby making the process cumbersome. For example, when a husband allows his wife to use part of the credit limit of his credit card, the application and examination of the wife's information by the credit card company are required. Further, for example, in the company, when a boss temporarily gives an admission to a specific area, which requires an employee card etc. to enter, to a subordinate, the examination of the subordinate by a department is required, thereby making the process cumbersome.

FIG. 3 is a diagram exemplifying deficiencies of the conventional technology. Therefore, even when the personal relationship between the parent card holder and the child card holder is special, the public key certificate and the data of the parent card and of the child card are required to be stored, respectively, and the examination of personal information of the child card holder by the card issuer is required.

Additionally, as described above, if the parent-child relation between the IC cards is defined, management of life cycle of the IC cards becomes problematic. For example, if the parent card becomes invalid, the question of whether the child card is to be invalidated or not arises. As for as known by the applicant, as to the management of life cycle of IC cards having a specific relationship, no technology has been disclosed.

### SUMMARY OF THE INVENTION

It is an objective of the present invention to provide a card utilization system, in which, if the personal relationship between the card holders is special, it is possible to easily grant the authority indicated by the one IC card to the other card, to set the parent-child relationship to plurality of IC cards, and to manage the life cycle of IC cards having the parent-child relationship.

In order to achieve the above objective, the parent-child card authentication system, in which a first-generation card as an ancestor card is authenticated by a root certificate authority, and a descendent card successively inheriting the authentication is generated, is provided. In this parent-child card authentication system, the root certificate authority comprises the generator for existence-proof information for first-generation card, which generates existence-proof information for first-generation card, which is for proving the existence of said first-generation card, in which the existence-proof information for first-generation card is existence-proof information for card, which includes information regarding authentication capability, which indicates whether the first-generation card is capable of operating as a certificate authority, and proves an existence of a specific card authenticated by the system, and the storage for confirmation information regarding existence-proof information for first-generation card, which stores confirmation information regarding existence-proof information for first-generation card, which is for confirming an authenticity of said existence-proof information for first-generation card, in which the confirmation information regarding existence-proof information for first-generation card is confirmation information for confirming the authenticity of existence-proof information for card, and the Nth-generation card stores existence-proof information for Nth-generation card, which includes information regarding authentication capability, which indicates whether the Nth-generation card is capable of operating as a certificate authority, and can be authenticated based on the confirmation information regarding existence-proof information for first-generation card in said root certificate authority, and generates existence-proof information for N+1th-generation card, which can be authenticated based on the confirmation information regarding existence-proof information for first-generation card in said root certificate authority, based on said information regarding authentication capability, and the N+1th-generation card stores said existence-proof information for N+1th-generation card, and stores identity-proof information for N+1th-generation card in secret state, in which the identity-proof information for N+1th-generation card is for proving that the card, of which existence is specified by said existence-proof information for N+1th-generation card, is the N+1th-generation card.

According to this parent-child card authentication system, in which the Nth-generation card is a parent card, the N+1th-generation card is a child card, and the existence-proof information for N+1th-generation card generated by the parent card is stored by the child card, in cases where the child card holder presents the existence-proof information for N+1th-generation card to the card issuer, the card issuer can know the issuance of the existence-proof information for N+1th-generation card by the parent card. For example, it becomes possible to know the personal relationship that the parent card holder can guarantee the child card holder, so that the examination for the child card holder becomes unnecessary. Note that the existence-proof information for N+1th-generation card may be the public key certificate of the child card.

In addition, a card mediation apparatus, which transmits the existence-proof information for N+1th-generation card from the N+1th-generation card to the Nth-generation card, is also provided.

In addition, the parent-child utilization system, in which a descendent card successively inheriting an authentication of a first-generation card as an ancestor card is generated and is utilized, wherein the Nth-generation card comprises the storage for management information of card, which stores the management information of Nth-generation card including the identification information of parent card, the self-identification information, and the management information of life cycle of Nth-generation card, is provided.

This makes it possible to provide a parent-child utilization system, which comprises the card, which determines the life cycle of itself in accordance with the life cycle of the parent card.

In addition, the Nth-generation card may acquire the information for managing the information indicating the life cycle of the N+1th-generation card based on the identification information of Nth-generation card.

This makes it possible to store the information for managing the information indicating the life cycle in the N+1th-generation card when the N+1th-generation card becomes the child card of the Nth-generation card.

In addition, the parent-child utilization system may comprise the server, which stores the state information indicating the state of life cycle of card, which is identified by the identification information of card, and is correlated with the identification information of card, acquires the identification information of parent card, self-identification information, and the information for managing the information indicating the life cycle of itself, based on the identification information of parent card, acquires the state information indicating the state of life cycle of the parent card from the identification information of the parent card, and generates the state information of life cycle of the Nth-generation card.

This makes it possible to determine the life cycle of the child card based on the life cycle of the parent card upon usage of the child card.

In addition, the server may change the state information of life cycle, which has been correlated with the identification information of said Nth-generation card, if the Nth-generation card is unusable, output a command, which disables said Nth-generation card, or request other server to output the command.

As described above, according to the present invention, it becomes possible to know the personal relationship between the parent card holder and the child card holder, and to easily grant the authority of the parent card to the child card. Moreover, it becomes possible to define the parent card and the child card by means of the data for inheriting the authentication from the root certificate authority, thereby efficiently using the memory area of the card. Furthermore, it becomes possible to manage the life cycle of IC cards having the parent-child relationship.

### BRIEF DESCRIPTION OF THE DRAWINGS

FIG. 1 is a diagram exemplifying of hierarchical structure constructed by the certificate authority and the end entities such as IC cards;

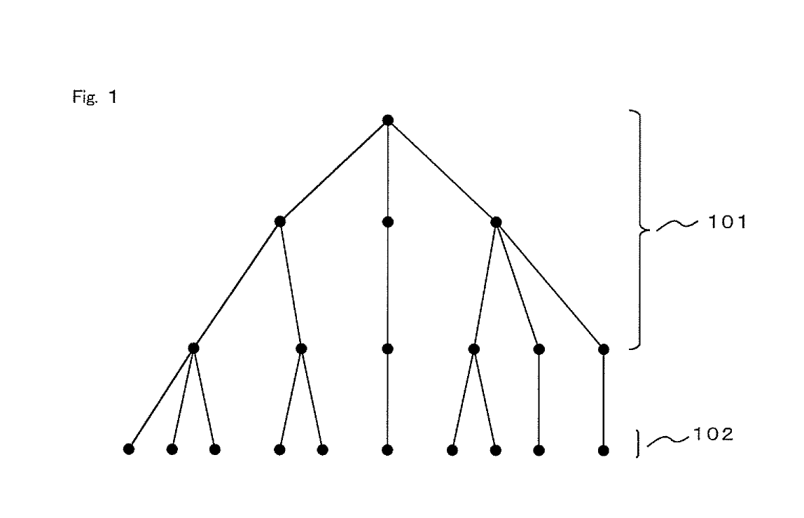

FIG. 2 is a flow chart of issuance process of IC card by the card issuer;

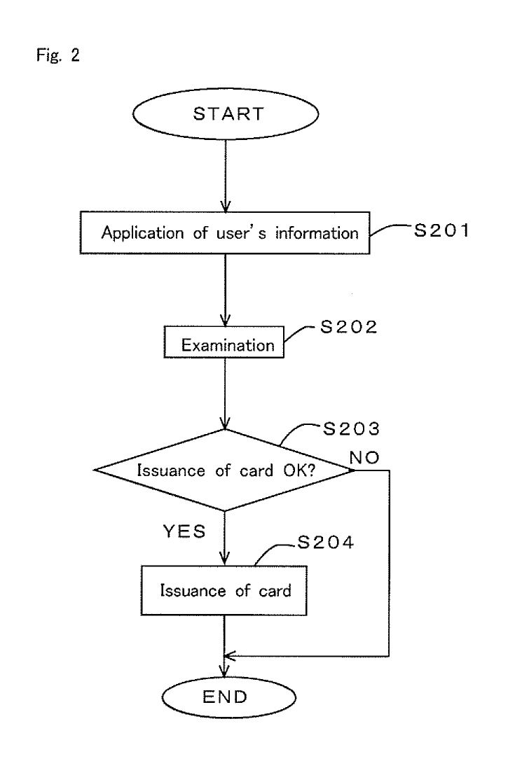

FIG. 3 is a diagram exemplifying deficiencies of the conventional technology;

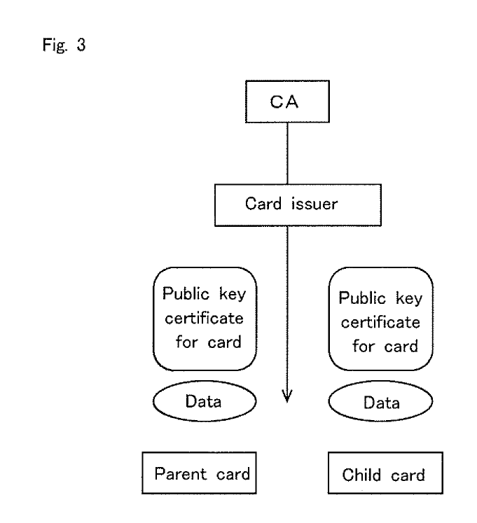

FIG. 4 is a schematic diagram of the present invention;

FIG. 5 is a diagram explaining the processes between the parent card, the card mediation apparatus, and the child card;

FIG. 6 is a schematic diagram of the parent-child card authentication system of the first embodiment;

FIG. 7 is a functional block diagram of the root certificate authority,

FIG. 8 is a diagram exemplifying a structure of the public key certificate;

FIG. 9 is a diagram of correspondence between the terms of the present invention and the terms in cases where the present invention is applied to the public key encryption;

FIG. 10 is a functional block diagram of the Nth-generation card of the first embodiment;

FIG. 11 is a functional block diagram of the N+1th-generation card of the first embodiment;

FIG. 12 is a functional block diagram of the N+1th-generation card of the fifth embodiment;

FIG. 13 is a functional block diagram of the N+1th-generation card of the sixth embodiment;

FIG. 14 is a functional block diagram of the Nth-generation card of the sixth embodiment;

FIG. 15 is a functional block diagram of the Nth-generation card of the eighth embodiment;

FIG. 16 is a functional block diagram of the card mediation apparatus of the ninth embodiment;

FIG. 17 is a sequential diagram of identification of existence of the Nth-generation card by the N+1th-generation card;

FIG. 18 is a sequential diagram of the process of the card mediation apparatus of the ninth embodiment;

FIG. 19 is a block diagram of the mediation apparatus generating the child card from the parent card;

FIG. 20 is a sequential diagram of data exchange between the card mediation apparatus, the parent card, and the card, which is to be a child card;

FIG. 21 is a diagram exemplifying a screen upon operation of the card mediation apparatus;

FIG. 22 is a functional block diagram of the parent card;

FIG. 23 is a diagram showing the format of command and response;

FIG. 24 is a functional block diagram of the child card;

FIG. 25 is a transition diagram of state of life cycle of a card;

FIG. 26 is a functional block diagram of the Nth-generation card of the parent-child card utilization system of the tenth embodiment;

FIG. 27 is a diagram exemplifying a screen upon operation of the card mediation apparatus;

FIG. 28 is a functional block diagram of the Nth-generation card acquiring the management information of life cycle of N+1th-generation card;

FIG. 29 is a block diagram of the server for state information of life cycle;

FIG. 30 is a functional block diagram of the server for state information of life cycle of the eleventh embodiment;

FIG. 31 is a diagram exemplifying operation of the server for state information of life cycle;

FIG. 32 is a flow chart of processing of the server for state information of life cycle;

FIG. 33 is a functional block diagram of the server for state information of life cycle of the twelfth embodiment;

FIG. 34 is a functional block diagram of the server for state information of life cycle of the thirteenth embodiment;

FIG. 35 is a block diagram of the fourteenth embodiment;

FIG. 36 is a functional block diagram of the server for state information of life cycle of the fourteenth embodiment.

### DETAILED DESCRIPTION OF THE PREFERRED EMBODIMENTS

Hereinafter, the general description of the present invention will be explained.

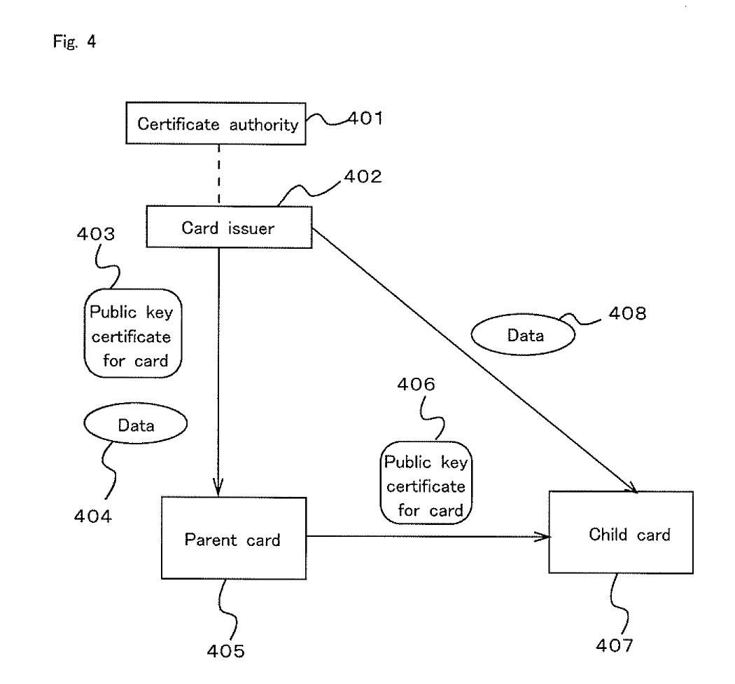

FIG. 4 is a schematic diagram of the present invention. The parent card 405 acquires tie public key certificate of card 403 through the card issuer 402, and acquires and stores the data 404, which indicates the authority etc., from the card issuer. In this state, in cases where the parent card 405 issues the public key certificate 406 of the child card 407, and stores it to the child card 407, if the child card holder requests the issuance of the card to the card issuer, the card issuer 402 confirms that the public key certificate stored by the child card 407 includes the signature of the parent card 405. After the confirmation is completed, the card issuer 402 causes the child card 407 to store the data 408, which indicates a part or all of the authority of the parent card 405, or a new authority. Note that, for this process, in %which the parent card 405 issues the public key certificate 406, and causes the child card 407to store it, for example, the card mediation apparatus, which will be described hereinbelow, is used.

In FIG. 4, the parent card 405 stores the public key certificate of card 404 issued by the card issuer 402, and the child card 407 stores the public key certificate 406 issued by the parent card 405, so that the child card 407 inherits the authentication by the card issuer 402 through the parent card 405. Further, if the card issuer 402 is authenticated by the certificate authority 401, the child card 407 inherits the authentication by the certificate authority 401.

Here, the public key certificate of the child card includes the information, in which the data acquired by hash operation on the public key of the child card is encrypted by the secret key of the parent card. The card issuer can detect whether the public key certificate stored by the child card is issued by the parent card according to the identity between the result of hash operation on the public key certificate of the child card and the result of decryption of the information, which has been encrypted by the secret key of the parent card, by the public key of the parent card. Moreover, it is possible to detect whether the child card is an authentic child card of the parent card by means of the following manner. For example, a number optionally selected is encrypted by means of the secret key of the child card, and the encrypted number is decrypted by the public key included in the public key certificate of the child card. If the same number is acquired, it is detected that the child card is an authentic child card of the parent card.

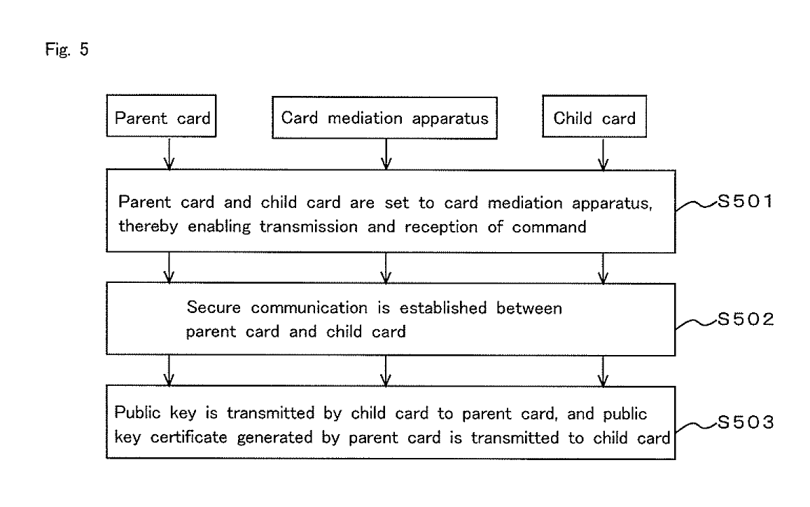

FIG. 5 is a diagram explaining the process between the parent card, the card mediation apparatus, and the child card. In step S501, the parent card and the child card are set to the card mediation apparatus, and the command becomes transmittable and receivable. Here, the ‘command’ means a command, which causes the parent card and the child card to carry out the process. As for the child card, for example, there is a command to output the public key, and a command to store the public key certificate. As for the parent card, for example, there is a command to generate a certificate for the public key. In step S502, a secure communication between the parent card and the child card is established. In step S503, the child card transmits the public key to the parent card though the card mediation apparatus, the public key certificate generated by the parent card is transmitted to the child card, and the child card stores it. Further, similarly to step S502. it is preferable to establish a secure communication between the parent card and the child card. However, if it is guaranteed that the physical environment or operation rule upon issuance of the public key certificate of the child card prevents fraud, the establishment of the secure communication between the cards may be omitted.

According to the above configuration, it becomes possible to correlate the parent card and the child card, and it becomes possible for the card issuer to know the correlation, thereby enabling the issuance process for the child card without examination of the information of the child card holder.

Embodiments of the present invention will be described hereinbelow with reference to the drawings. The present invention is not to be limited to the embodiments and may be embodied in various forms without departing from the scope thereof.

### First Embodiment

As the first embodiment, the parent-child card authentication system, in which a first-generation card as an ancestor card authenticated by a root certificate authority, and a descendent card successively inheriting the authentication is generated, will be described.

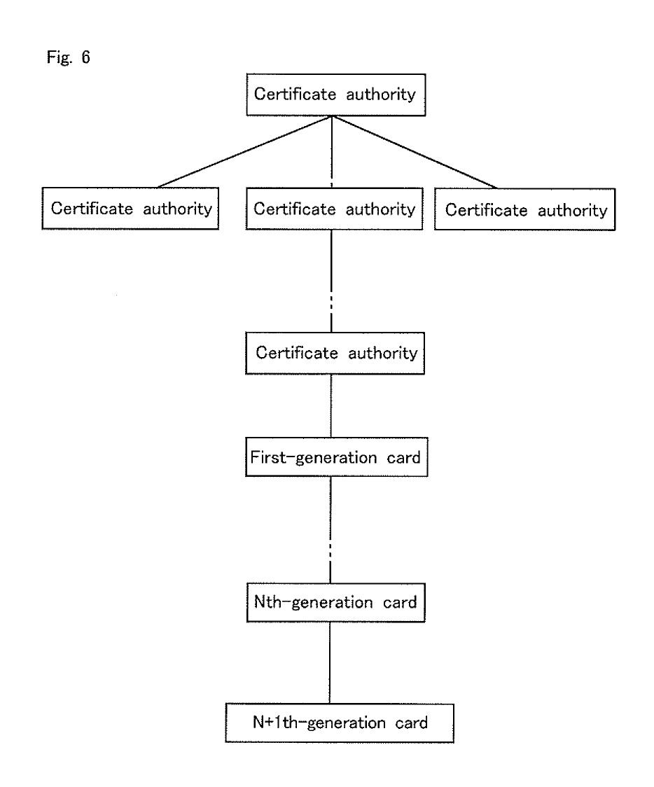

FIG. 6 is a schematic diagram of the parent-child card authentication system of the first embodiment. In the upper portion of FIG. 6, the tier of certificate authority is indicated. In the relation of these certificate authorities, the certificate authority in the upper tier authenticates the certificate authority directly below. The root certificate authority may be the certificate authority locating at the root in FIG. 6, or may be the certificate authority directly above the first-generation card. In cases where the root certificate authority is located at the root portion in FIG. 6, the ‘first-generation card authenticated by the root certificate authority’ corresponds to the first-generation card directly authenticated by the root certificate authority, and to the first-generation card indirectly authenticated by the root certificate authority. The ‘first-generation card directly authenticated by the root certificate authority’ corresponds to the first-generation card authenticated by the root certificate authority itself. The ‘first-generation card indirectly authenticated by the root certificate authority’ corresponds to the first-generation card authenticated by the other root certificate authority, which is directly or indirectly authenticated by the root certificate authority.

In the lower portion of FIG. 6, the descendent cards up to the N+1th-generation, which successively inherit the authentication from the first-generation card as an ancestor card, are indicated. The terms ‘successively inherit die authentication’ means that the authentication of the Mth-generation card depends on the authentication of M−1th-generation card, and consequently, depends on the authentication of the first-generation card by the root certificate authority. Accordingly, in the first embodiment, the card is an end-entity and a certificate authority as well. Note that, in FIG. 6, although the cards are linearly arranged, branching, therefore, the case that a certain card has a plurality of child cards may be allowed.

Therefore, the method for determining whether a certain card (hereinafter, referred to as ‘a card in question’) belongs to the parent-child card authentication system of the present invention is as follows. The public key certificate of the card in question is acquired, the parent card, which has generated the public key certificate, is specified, and the public key certificate is examined by means of the public key of die parent card. If the examination is successful, it is determined whether the parent card belongs to the parent-child card authentication system of the present invention. Through repetition of this process, finally, the first-generation card is specified. If the first-generation card is authenticated by the root certificate authority, it is determined that the card in question belongs to the parent-child card authentication system of the present invention.

The parent-child card authentication system of the first embodiment comprises the root certificate authority, the Nth-generation card, which inherits the authentication by the root certificate authority, and the N+1th-generation card, which is a child card of the Nth-generation card, and is authenticated by the Nth-generation card.

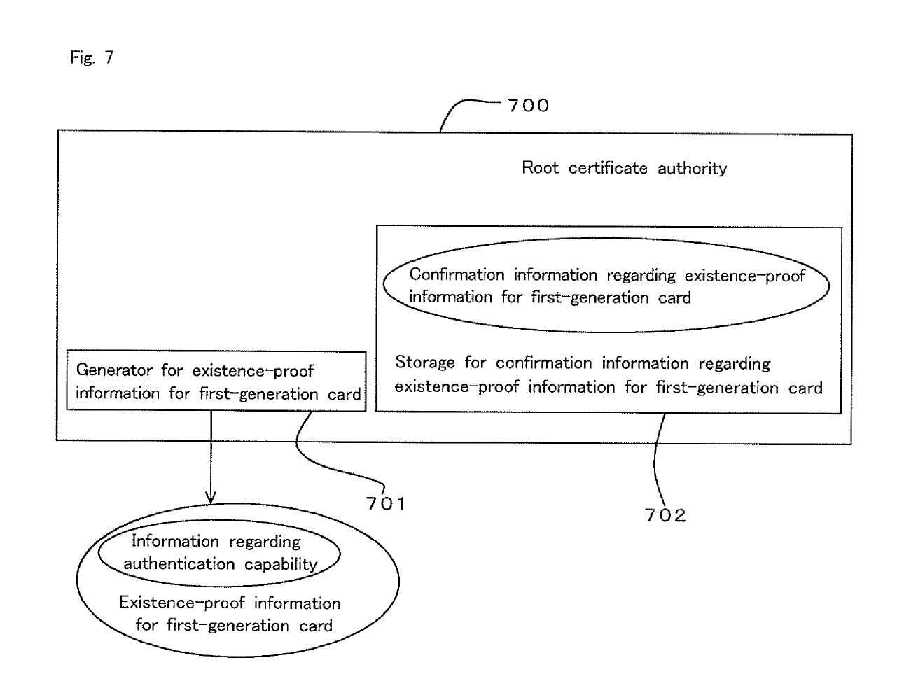

FIG. 7 is a functional block diagram of the root certificate authority. The root certificate authority (700) comprises the generator for existence-proof information for first-generation card (701), and the storage for confirmation information regarding existence-proof information for first-generation card (702). Note that, the root certificate authority may be implemented as a server using a computer etc.

The generator for existence-proof information for first-generation card (701) generates existence-proof information for first-generation card, which is for proving the existence of said first-generation card, in which the existence-proof information for first-generation card is existence-proof information for card, which includes information regarding authentication capability of the first-generation card.

The ‘information regarding authentication capability of first-generation card’ corresponds to information indicating whether the first-generation card is capable of operating as a certificate authority. The terms ‘operating as a certificate authority’ mean generating the existence-proof information for the other card as described hereinbelow. The ‘existence-proof information for card’ is information for proving an existence of a specific card authenticated by the present system. Therefore, it is information for proving that the card exists as a card, which belongs to the parent-child card authentication system of the first embodiment. In the present application, any information, which fulfills this definition, corresponds to the existence-proof information for card. An example of the existence-proof information for card includes the public key certificate of card in public key encryption. The reason for this is that, according to the above-mentioned method, it is possible to examine whether the card belongs to the parent-child card authentication system of the first embodiment based on the public key certificate of card. Therefore, if the existence-proof information for card is the public key certificate of card, the generator for existence-proof information for first-generation card generates the information, which includes the signature for the public key of the first-generation card by means of the secret key of the root certificate authority (700).

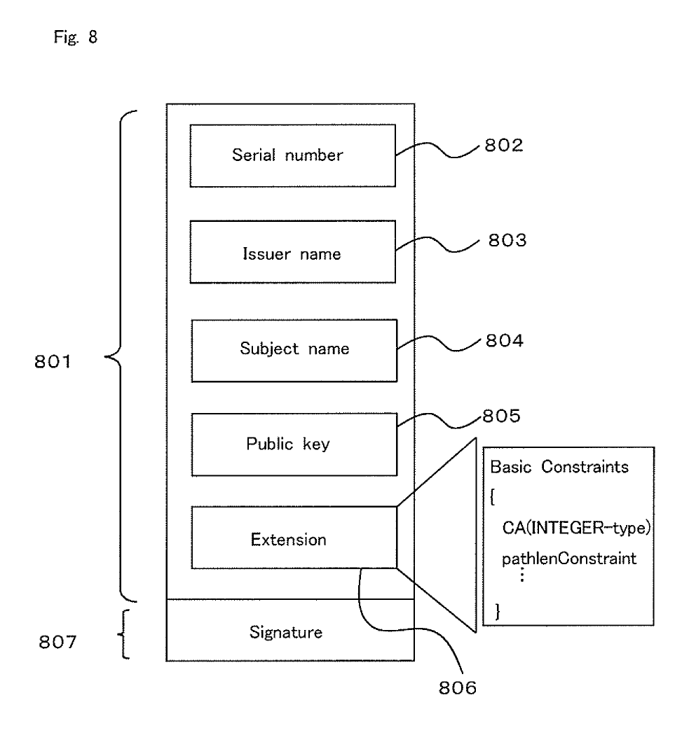

FIG. 8 is a diagram exemplifying a structure of the public key certificate. The item of the ‘serial number’ 802 is a number etc. indicating where the public key certificate has been generated in the chronological order for the issuer. The item of the ‘issuer’ 803 indicates an entity generating the public key certificate. The item of the ‘subject name’ 804 indicates a subject, to which the public key certificate has been issued. The item of the ‘public key’ 805 is a public key included in the public key certificate. The item of the ‘extension’ 806 is a portion-extending format of the public key certificate. The signature 807 is generated by encrypting hashed values of the above items 801 by means of the secret key of the issuer. The extension may include the above-mentioned information regarding authentication capability. On the right side of FIG. 8, the structure of extension by X.509 format is exemplified. In the portion of CA (INTEGER type), the value, which indicates that the entity certified by the public key certificate is a pure end-entity, a pure certificate authority, or both end-entity and certificate authority. Here, the ‘pure certificate authority’ corresponds to a certificate authority, which does not perform as an end-entity, and the ‘pure end-entity’ corresponds to an end-entity, which does not perform as a certificate authority. In addition, the other configuration, in which CA is BOOLEN type, and it is indicated whether the entity performs as a certificate authority or as an end-entity, may be used. For example, the configuration, in which the item ‘CAAttribute’ is added, and it is indicated whether the entity performs as both certificate authority and end-entity, may be used. For example, in cases where a card performs as a certificate authority, a value of CA is false, and a value of CAAttribute is true. When the value of CAAttribute is true, it is indicated that the entity performs as an end-entity, and when the value of CAAttribute is true, it is indicated that the entity further performs as a certificate authority.

The storage for confirmation information regarding existence-proof information for first-generation card (702) stores confirmation information regarding existence-proof information for first-generation card. The ‘confirmation information regarding existence-proof information for first-generation card’ is confirmation information for confirming an authenticity of said existence-proof information for first-generation card, in which the confirmation information regarding existence-proof information for first-generation card is confirmation information for confirming die authenticity of existence-proof information for card. In the present application, any information, which fulfills this definition, corresponds to the confirmation information regarding existence-proof information for first-generation card. An example of the confirmation information regarding existence-proof information for first-generation card includes the public key of the root certificate authority in public key encryption. The reason for this is that if the confirmation information regarding existence-proof information for card is the confirmation information regarding existence-proof information for first-generation card, the public key certificate includes the information encrypted by the secret key of the root certificate authority, so that it becomes possible to confirm that the public key certificate is authentic.

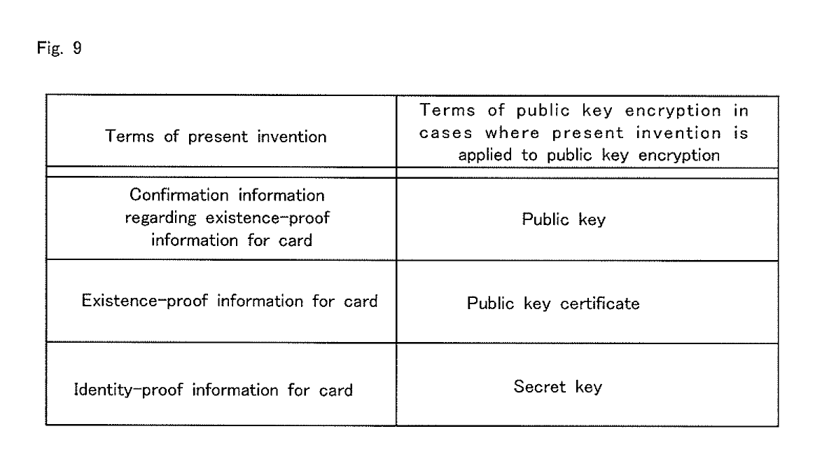

FIG. 9 is a diagram of the correspondence between the terms of the present invention and the terms in cases where the present invention is applied to the public key encryption. The terms in the present application include the existence-proof information for card, the confirmation information regarding existence-proof information for card, and the identity-proof information for card. As described above, the existence-proof information for card, and the confirmation information regarding existence-proof information for card correspond to the public key certificate, and to the public key, respectively.

The ‘identity-proof information for card’ is information for proving that the card, of which existence is specified by the existence-proof information for card, is the card itself. In the present application, any information, which fulfills this definition, corresponds to the identity-proof information for card. An example of the identity-proof information for card includes the secret key of the card. Therefore, a number optionally selected is given to the card, of which existence is specified by the public key certificate. The card is encrypted by the secret key of it, and is decrypted by the public key included in the public key certificate. Then, it is confirmed whether the number is same as the optionally selected number, so that it is determined whether the card is the card, of which existence is specified by the public key certificate.

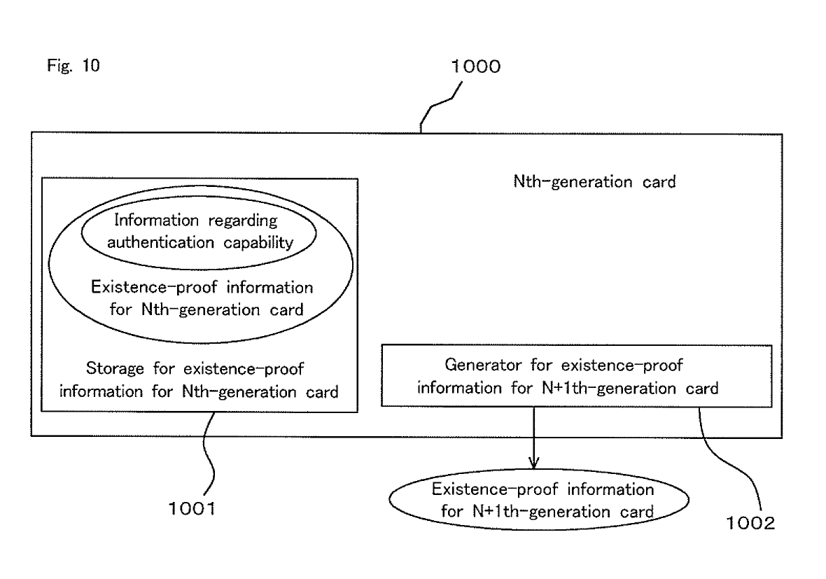

FIG. 10 is a functional block diagram of the Nth-generation card of the first embodiment. The Nth-generation card 1000 comprises the storage for existence-proof information for Nth-generation card 1001, and the generator for existence-proof information for N+1th-generation card 1002. Note that the Nth-generation card can be implemented, for example, by installing an application program to IC card etc. having a memory and CPU etc.

The ‘storage for existence-proof information for Nth-generation card’ 1001 stores existence-proof information for Nth-generation card. The existence-proof information for Nth-generation card is information, which includes information regarding authentication capability, which indicates whether the Nth-generation card is capable of operating as a certificate authority, and can be authenticated based on the confirmation information regarding existence-proof information for first-generation card in said root certificate authority. The ‘Nth-generation card’ corresponds to the Nth-generation card 1000. The terms ‘based on the confirmation information regarding existence-proof information for first-generation card’ means that if the Nth-generation card is the first-generation card, the authenticity of the existence-proof information can be certified by the confirmation information regarding existence-proof information for first-generation card, and if the Nth-generation card is the other-generation card, the authenticity of the existence-proof information can be indirectly certified. The terms ‘indirectly’ means that, if the parent card is the first-generation card, the authenticity of the existence-proof information for first-generation card of the parent card can be directly certified by the confirmation information regarding existence-proof information for first-generation card, and if the parent card is not the first-generation card, the authenticity of the existence-proof information for the parent card can be indirectly certified, and the authenticity of the existence-proof information for Nth-generation card can be certified by the confirmation information regarding existence-proof information for parent card. An example of the existence-proof information for Nth-generation card includes the public key certificate of the Nth-generation card 1000.

The ‘generator for existence-proof information for N+1th-generation card’ 1002 generates existence-proof information for N+1th-generation card based on said information regarding authentication capability. The ‘existence-proof information for N+1th-generation card’ is information, which can be authenticated based on the confirmation information regarding existence-proof information for first-generation card in said root certificate authority. The ‘information regarding authentication capability’ is the information regarding authentication capability included in the existence-proof information for Nth-generation card stored in the storage for existence-proof information for Nth-generation card 1001. The terms ‘generates existence-proof information for N-+1th-generation card based on said information regarding authentication capability’ means that if the information regarding authentication capability indicates that the Nth-generation card is capable of operating as a certificate authority, the existence-proof information for N+1th-generation card is generated, and if not, the existence-proof information for N+1th-generation card is not generated. An example of the existence-proof information for N+1th-generation card includes the public key certificate of the N+1th-generation card.

Note that, if the existence-proof information for N+1th-generation card is generated, it may be specified how the information regarding authentication capability included in the existence-proof information for N+1th-generation card is generated. For example, in cases where the after-mentioned card mediation apparatus is used, the specification may be carried out by operating the card mediation apparatus. In addition, the value of ‘pathLenConstraint’ in the structure of extension shown in FIG. 8 indicates the limitation of number of generations of card, which performs as a certificate authority, so that the specification may be carried out. For example, the information regarding authentication capability may be generated, so that if the value of ‘pathLenConstraint’ of the existence-proof information for N+1th-generation card, which is acquired by subtracting from the value of ‘pathLenConstraint’ of the existence-proof information for Nth-generation card, is positive value, the N+1th-generation card performs as a certificate authority, and if not, the N+1th-generation card does not perform as a certificate authority.

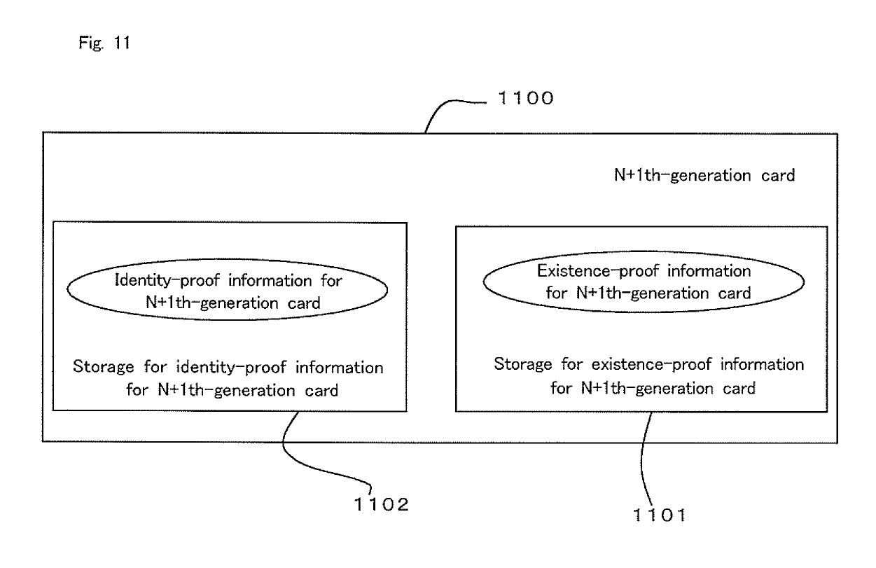

FIG. 11 is a functional block diagram of the N+1th-generation card of the first embodiment. The N+1th-generation card 1100 comprises the storage for existence-proof information for N+1th-generation card 1101, and the storage for identity-proof information for N+1th-generation card 1102. The N+1th-generation card can be implemented, for example, by installing an application program to IC card etc. having a memory and CPU etc. Note that, it is preferable that the memory has the tamper-resistant area.

The ‘storage for existence-proof information for N+1th-generation card’ 1101 stores said existence-proof information for N+1th-generation card. The ‘existence-proof information for N1th-generation card’ corresponds to the existence-proof information for N+1th-generation card generated by the generator for existence-proof information for N+1th-generation card 1002.

The ‘storage for identity-proof information for N+1th-generation card’ 1102 can store identity-proof information for N+1th-generation card in secret state. The identity-proof information for N+1th-generation card has been described as the identity-proof information for card with reference to FIG. 9. An example of the identity-proof information for N+1th-generation card includes the secret key of the N+1th-generation card 1100. The terms ‘can store in secret state’ means that, for example, a storing in the tamper-resistant area is possible.

The processing flow of the parent-child card authentication system of the first embodiment is as follows. At the outset, the first-generation card is authenticated. For this purpose, the existence-proof information for first-generation card is generated by the root certificate authority (the generation step for existence-proof information for first-generation card), and the confirmation information regarding existence-proof information for first-generation card is stored (the storing step for confirmation information regarding existence-proof information for first-generation card). Subsequently, if the parent-child card authentication system of the first embodiment carries out authentication up to the Nth-generation card, the existence-proof information for Nth-generation card is stored by the N+1th-generation card (the storing step for existence-proof information for Nth-generation card). Subsequently, the Nth-generation card generates the existence-proof information for Nth-generation card based on the information regarding authentication capability (the generation step for existence-proof information for N+1th-generation card). The N+1th-generation card stores the existence-proof information for N+1th-generation card generated by the generation step for existence-proof information for N+1th-generation card (the storing step for existence-proof information for N+1th-generation card), and can store the identity-proof information for N+1th-generation card in secret state (the storing step for identity-proof information for N+1th-generation card). Note that the identity-proof information for N+1th-generation card may be storable in a secret state after being generated in the interior of N+1th-generation card, or may be storable in secret state after being generated in the exterior of N+1th-generation card.

According to the first embodiment, it becomes possible to prove that the N+1th-generation card is a child card of the Nth-generation card based on the existence-proof information for N+1th-generation card, and to prove that the card, of which existence is specified by the existence-proof information for N+1th-generation card, is the N+1th-generation card based on the identity-proof information for N+1th-generation card. Consequently, it becomes possible to know the personal relationship that the Nth-generation card holder allows the issuance of the existence-proof information for N+1th-generation card, so that it becomes possible to easily grant the part or all of the authority, or the different authority indicated by the Nth-generation card to the N+1th-generation card holder, and to confirm that granting such authority causes no problems.

### Second Embodiment

As the second embodiment, the parent-child card authentication system, wherein the existence-proof information for N+1th-generation card includes self-identification information for uniquely identifying the N+1th-generation card, will be described.

The second embodiment is a parent-child card authentication system according to the first embodiment, wherein the existence-proof information for N+1th-generation card includes self-identification information for uniquely identifying the N+1th-generation card. The terms ‘uniquely identifying’ means that the N+1th-generation card is uniquely specified.

In an example of the configuration, in which the self-identification information is included, the value stored as a subject in FIG. 8 may be the value acquired by a combination of the name or identifier of the manufacturer of N+1th-generation card, and the production number of the manufacturer. Alternatively, instead of such a value, the name of the N+1th-generation card holder may be used. For this purpose, firstly, the generator for existence-proof information for N+1th-generation card 1002 acquires the self-identification information for N+1th-generation card upon generating the existence-proof information for N+1th-generation card.

According to the second embodiment, it is indicated for which card the existence-proof information for N+1th-generation card is generated, so that it becomes possible to indicate that the Nth-generation card holder recognizes the N+1th-generation card, or decides to generate the existence-proof information for N+1th-generation card with a certain will, thereby providing evidence that if the authority is granted to the N+1th-generation card, no problem is caused.

### Third embodiment

As the third embodiment, the parent-child card authentication system, wherein the existence-proof information for N+1th-generation card includes identification information for uniquely identifying the Nth-generation card, will be described.

The third embodiment is a parent-child card authentication system according to the first or second embodiment, wherein the existence-proof information for N+1th-generation card includes parent-identification information for uniquely identifying the Nth-generation card. The terms ‘uniquely identifying’ means that the Nth-generation card is uniquely specified.

In an example of the configuration, in which the parent-identification information is included, the value stored as the issuer in FIG. 8 may be the value acquired by a combination of the name or identifier of the manufacturer of Nth-generation card, and the production number of the manufacturer. Alternatively, instead of such a value, the name of the Nth-generation card holder or the card ID of the Nth-generation card may be used.

According to the third embodiment, it is indicated for which card the existence-proof information for N+1th-generation card is generated, so that it becomes possible to easily know that the N+1th-generation card is a child card of which Nth-generation card, thereby enabling smooth issuance of child card.

### Fourth embodiment

As the fourth embodiment, the parent-child card authentication system, wherein the existence-proof information for N+1th-generation card includes information for specifying the ancestor card of the N1th-generation card, will be described.

The fourth embodiment is a parent-child card authentication system according to any one of the first to third embodiments, wherein the existence-proof information for N+1th-generation card includes information for specifying the ancestor card of the N+1th-generation card, will be described. The terms ‘uniquely identifying’ means that the ancestor card of the N+1th-generation card is uniquely specified. The ‘ancestor card of the N+1th-generation card’ corresponds to any one of the Nth-generation cards, the N−1th-generation card, . . . , the second-generation card, or the first-generation card.

In an example of the configuration, in which the information for specifying the ancestor card is included, the value of the extension in Fig, 8 may include the value acquired by a combination of the name or identifier of the manufacturer of the ancestor card, and the production number of the manufacturer. Alternatively, instead of such value, the name of the ancestor card holder or the card ID of the ancestor card may be used.

According to the fourth embodiment, it becomes possible to provide the same effect as that of the third embodiment. In addition, it is possible to know the ancestor card of the N+1th-generation card, so that it becomes possible to smoothly determine whether the N+1th-generation card is authenticated by the parent-child card authentication system of the fourth embodiment.

### Fifth Embodiment

As the fifth embodiment, the parent-child card authentication system, comprising the N+1th-generation card, which is able to generate identity-proof information for N+1th-generation card, will be described.

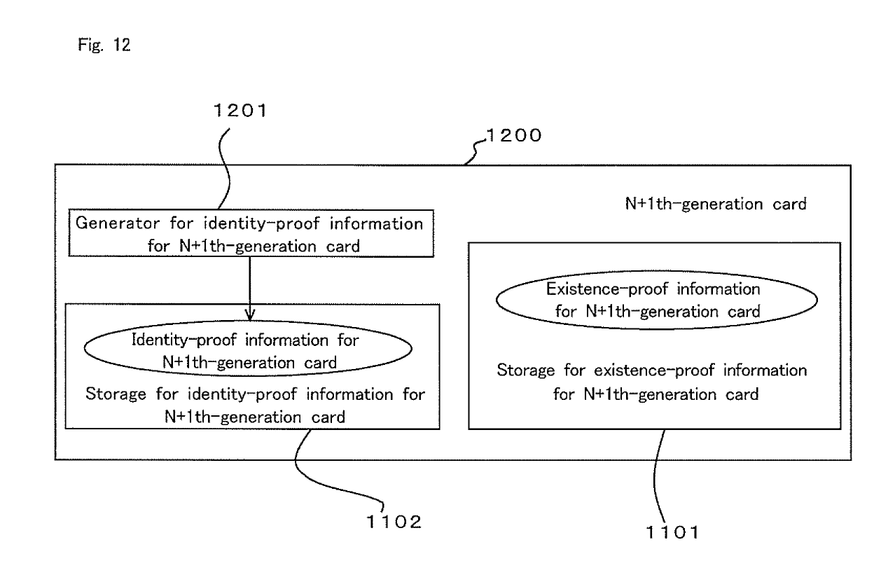

FIG. 12 is a functional block diagram of the N+1th-generation card of the fifth embodiment. The N+1th-generation card 1200 comprises the storage for existence-proof information for N+1th-generation card 1101, the storage for identity-proof information for N+1th-generation card 1102, the generator for identity-proof information for N+1th-generation card 1201. Therefore, the parent-child card authentication system of the fifth embodiment is the parent-child card authentication system according to any one of the first to fourth embodiments, wherein the N+1th-generation card comprises the generator for identity-proof information for N+1th-generation card,

The ‘generator for identity-proof information for N−1th-generation card’ 1201 generates identity-proof information for N+1th-generation card. For example, on the basis of the operation carried out for the N+1th-generation card, or of the surrounding environment of the N+1th-generation card, the identity-proof information for N+1th-generation card is generated. An example of the operation includes an operation carried out by a person by means of an apparatus, to which the N+1th-generation card is connected, such as a keyboard. Examples of the surrounding environment include temperature, humidity, oxygen density, or acceleration. The generator for identity-proof information for N+1th-generation card 1201 generates, for example, prime number according to typing speed, or temperature etc., and generates the identity-proof information for N+1th-generation card.

It is necessary to store the identity-proof information for N+1th-generation card. According to the fifth embodiment, the identity-proof information for N+1th-generation card is generated in the N+1th-generation card, so that it becomes possible to securely store the identity-proof information for N+1th-generation card.

### Sixth Embodiment

As the sixth embodiment, the parent-child card authentication system, wherein the N+1th-generation card outputs the confirmation information regarding existence-proof information for card to the Nth-generation card, and the Nth-generation card generates the existence-proof information for card from the confirmation information regarding existence-proof information for card, and outputs it to the N+1th-generation card, will be described.

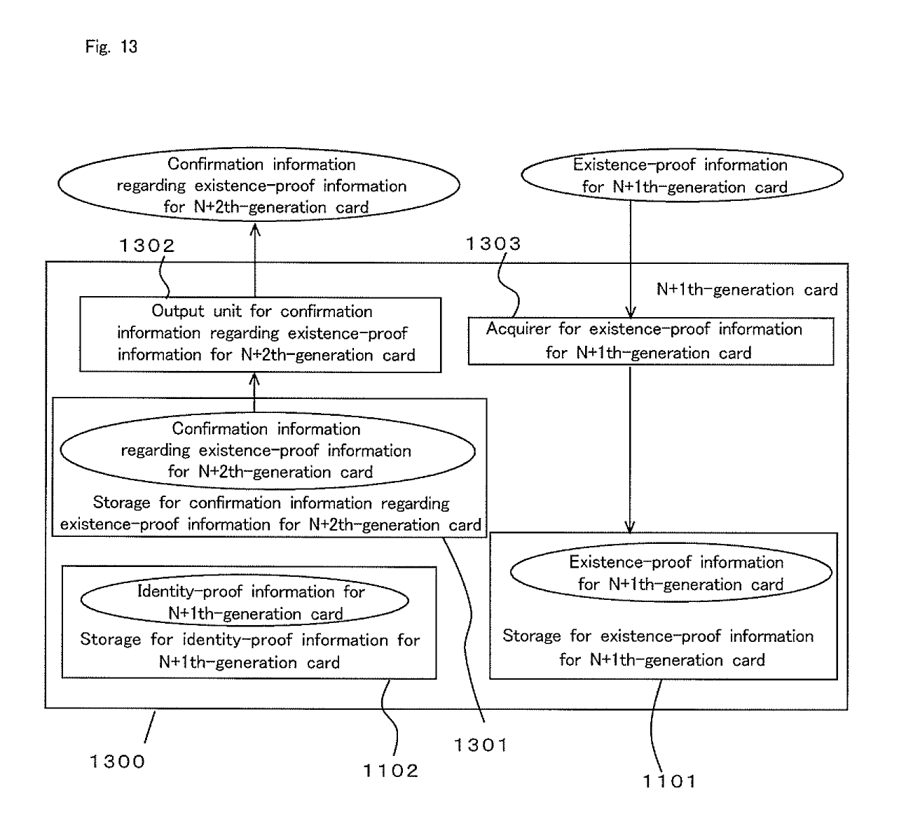

FIG. 13 is a functional block diagram of the N+1th-generation card of the sixth embodiment. The N+1th-generation card 1300 comprises the storage for existence-proof information for N+1th-generation card 1101, the storage for identity-proof information for N+1th-generation card 1102, the storage for confirmation information regarding existence-proof information for N+2th-generation card 1301, the output unit for confirmation information regarding existence-proof information for N+2th-generation card 1302, and the acquirer for existence-proof information for N+1th-generation card 1303. Therefore, N+1th-generation card 1300 is the N+1th-generation card of the parent-child card authentication system according to any one of the first to fifth embodiments, comprising the storage for confirmation information regarding existence-proof information for N+2th-generation card 1301, the output unit for confirmation information regarding existence-proof information for N+2th-generation card 1302, and the acquirer for existence-proof in formation for N+1th-generation card 1303.

The ‘storage for confirmation information regarding existence-proof information for N+2th-generation card’ 1301 stores confirmation information regarding existence-proof information for N+2th-generation card, which has one-to-one correspondence with the identity-proof information for N+1th-generation card stored by said storage for identity-proof information for N+1th-generation card 1102.

For example, in cases where the identity-proof information for N+1th-generation card is the secret key of the N+1th-generation card, the confirmation information regarding existence-proof information for N+2th-generation card corresponds to the public key of the N+1th-generation card. The reason for this is that if the N+2th-generation card exists, the information for confirming the authenticity of the N+2th-generation card corresponds to the public key of the N+1th-generation card, which is the confirmation information regarding existence-proof information for N+2th-generation card.

The ‘output unit for confirmation information regarding existence-proof information for N+2th-generation card’ 1302 outputs the confirmation information regarding existence-proof information for N+2th-generation card stored by said storage for confirmation information regarding existence-proof information for N+2th-generation card 1301 to the Nth card. The output to the Nth-generation card may be carried out in a direct manner to the N+2th-generation card, or in an indirect manner by means of the after-mentioned card mediation apparatus etc. In addition, the output may be carried out in a contact or non-contact environment.

The ‘acquirer for existence-proof information for N+1th-generation card’ 1303 acquires the existence-proof information for N+1th-generation card outputted by said Nth-generation card. The ‘Nth-generation card’ corresponds to the Nth-generation card, to which the confirmation information regarding existence-proof information for N+2th-generation card is outputted by the output unit for confirmation information regarding existence-proof information for N+2th-generation card. The acquisition by the acquirer for existence-proof information for N+1th-generation card 1303 may be carried out by directly acquiring the existence-proof information for N+1th-generation card outputted by the Nth-generation card, or by indirectly acquiring it by means of the card mediation apparatus etc. In addition, the output may be carried out in a contact or non-contact environment.

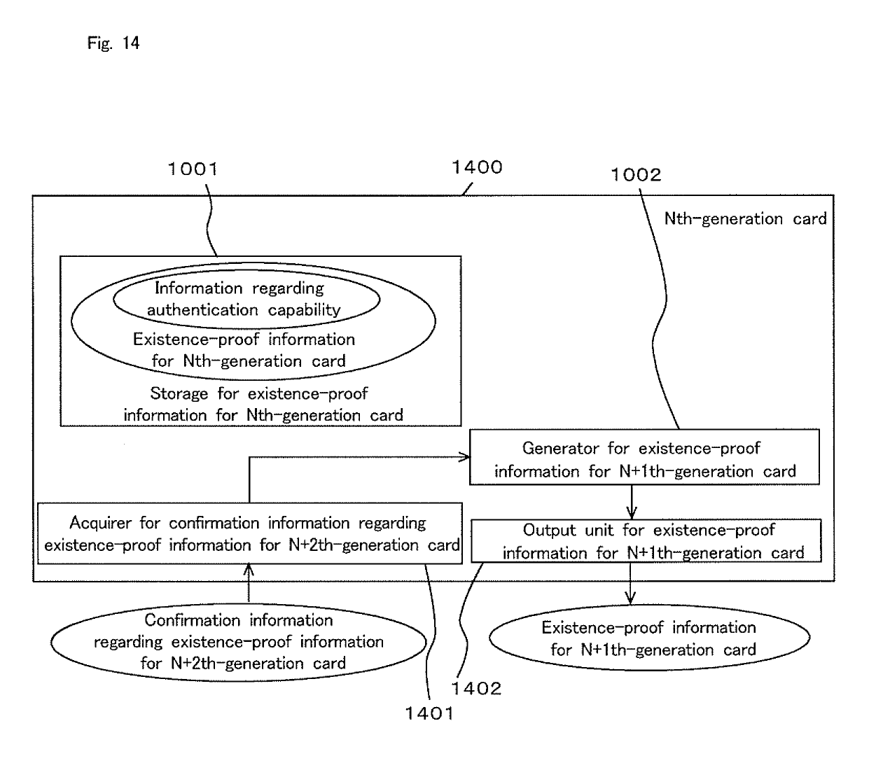

FIG. 14 is a functional block diagram of the Nth-generation card of the sixth embodiment. The Nth-generation card 1400 comprises the storage for existence-proof information for Nth-generation card 1001, the generator for existence-proof information for N+1th-generation card 1002, the acquirer for confirmation information regarding existence-proof information for N+2th-generation card 1401, and the output unit for existence-proof information for N+1th-generation card 1402. Therefore, the Nth-generation card 1400 is the Nth-generation card of the parent-child card authentication system according to any one of the first to fifth embodiments, comprising the acquirer for confirmation information regarding existence-proof information for N+2th-generation card 1401, and the output unit for existence-proof information for N+1th-generation card 1402.

The ‘acquirer for confirmation information regarding existence-proof information for N+2th-generation card’ 1401, acquires the confirmation information regarding existence-proof information for N+2th-generation card outputted by said output unit for confirmation information regarding existence-proof information for N+2th-generation card 1302 of said N+1th-generation card.

The ‘output unit for existence-proof information for N+1th-generation card’ 1402 outputs the existence-proof information for N+1th-generation card generated by said generator for existence-proof information for N+1th-generation card 1002.

According to the sixth embodiment, the generator for existence-proof information for N+1th-generation card 1002 of the Nth-generation card 1400 generates the existence-proof information for N+1th-generation card based on the confirmation information regarding existence-proof information for N+2th-generation card acquired by the acquirer for confirmation information regarding existence-proof information for N+2th-generation card 1401. This generation is carried out so as to fulfill the definition of the existence-proof information for N+1th-generation card. If the public key encryption is used, the signing is carried out for the public key of the N+1th-generation card, which is the confirmation information regarding existence-proof information for N+2th-generation card, by means of the secret key of the Nth-generation card, so that the public key certificate of N+1th-generation card, which is the existence-proof information for N+1th-generation card, is generated.

The processing flow of the parent-child card authentication system of the sixth embodiment is as follows. At the outset, in the Nth-generation card, the confirmation information regarding existence-proof information for N+2th-generation card stored by the storage for confirmation information regarding existence-proof information for N+2th-generation card 1301 is read, and is outputted to the Nth-generation card by the output unit for confirmation information regarding existence-proof information for N+2th-generation card 1302. According to this, in the Nth-generation card, the confirmation information regarding existence-proof information for N+2th-generation card is acquired by the acquirer for confirmation information regarding existence-proof information for N+2th-generation card 1401, and the existence-proof information for N+1th-generation card is generated by the generator for existence-proof information for N+1th-generation card 1002, and is outputted to the N+1th-generation card by the output unit for existence-proof information for N+1th-generation card 1402. Then, in the N+1th-generation card, the existence-proof information for N+1th-generation card is acquired by the acquirer for existence-proof information for N+1th-generation card 1303, and is stored by the storage for existence-proof information for N+1th-generation card 1101.

According to the sixth embodiment, it becomes possible to add the N+1th-generation card to the parent-child card authentication system of the present application.

### Seventh Embodiment

As the seventh embodiment, the parent-child card authentication system by means of the public key encryption will be described.

The parent-child card authentication system of the seventh embodiment is the parent-child card authentication system according to any one of the first to sixth embodiments, wherein the existence-proof information for first-generation card generated by said generator for existence-proof information for first-generation card is information signed by means of a root secret key pair with a root public key used in public key encryption used for communication by said root certificate authority, the confirmation information regarding existence-proof information for N+1th-generation card stored by said storage for confirmation information regarding existence-proof information for N+1th-generation card is said root public key, and the identity-proof information for N+1th-generation card stored by said storage for identity-proof information for N+1th-generation card is a secret key of N+1th-generation card.

The case of using the public key encryption has been described in the first embodiment etc., so that the description thereof will be omitted.

According to the seventh embodiment, the authentication of the parent/child card is carried out by means of the public key certificate and the secret key, so that other data is not required, and it becomes possible to prevent the memory capacity of the card from overload.

### Eighth Embodiment

As the eighth embodiment, the Nth-generation card will be described. Although the Nth-generation card in the parent-child card authentication system has been described, hereinabove, the Nth-generation card will be taken up and described.

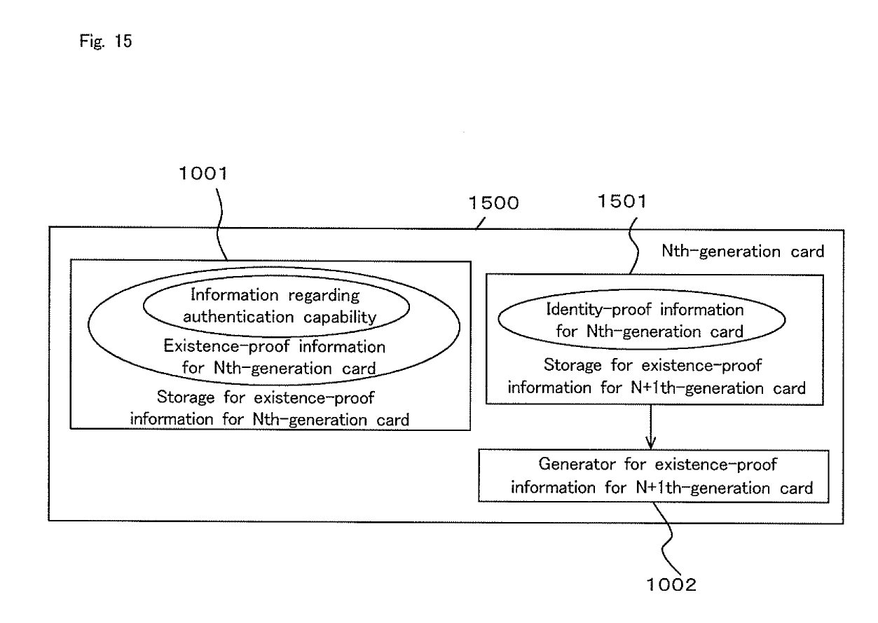

FIG. 15 is a functional block diagram of the Nth-generation card of the eighth embodiment. The Nth-generation card of the eighth embodiment is the card, which inherits an authentication of a first-generation card as an ancestor card authenticated by a root certificate authority, comprising the storage for existence-proof information for Nth-generation card 1001, the storage for identity-proof information for Nth-generation card 1501, and the generator for existence-proof information for N+1th-generation card 1002.

The ‘existence-proof information for Nth-generation card’ 1001, as defined in the first embodiment, stores existence-proof information for Nth-generation card, which includes information regarding authentication capability, which indicates whether the Nth-generation card is capable of operating as a certificate authority, and proves an existence of a specific card authenticated based on the authentication of the root certificate authority, and can be authenticated based on the confirmation information regarding existence-proof information for first-generation card in said root certificate authority. Note that, since the first embodiment is premised on the parent-child card authentication system, the existence-proof information for card is defined as ‘existence of a specific card authenticated by the system’. Meanwhile, in the eighth embodiment, it is defined as ‘existence of a specific card authenticated based on the authentication of the root certificate authority’. In this case, the authentication of the root certificate authority is the authentication for the Nth-generation card, and the Nth-generation card inherits the authentication for the first-generation card.

The ‘storage for identity-proof information for Nth-generation card’ 1501 stores identity-proof information for Nth-generation card, in which the identity-proof information for Nth-generation card is for proving that the card, of which existence is specified by said existence-proof information for Nth-generation card, is the N+1th-generation card.

The ‘generator for existence-proof information for N+1th-generation card’ 1002, which gives signature in accordance with the identity-proof information for Nth-generation card stored by said storage for identity-proof information for Nth-generation card 1501, and generates existence-proof information for N+1th-generation card based on said information regarding authentication capability.

The processing flow of the Nth-generation card of the eighth embodiment is as follows. At the outset, the identity-proof information for Nth-generation card is read from the storage for identity-proof information for Nth-generation card 1501. Subsequently, the existence-proof information for N+1th-generation is generated by the generator for existence-proof information for N+1th-generation card 1002. In cases where the public key encryption is used, the generator for existence-proof information for N+1th-generation card 1002 may acquire the public key of the N+1th-generation card, and may generate the existence-proof information for N+1th-generation card based on the public key.

The main effect of the eighth embodiment is the same as that of the first embodiment etc.

### Ninth Embodiment

As the ninth embodiment, the card mediation apparatus, which mediates authentication of the N+1th-generation card by the Nth-generation card, will be described. Therefore, the card mediation apparatus of the ninth embodiment is the card mediation apparatus, which mediates authentication of the N+1th-generation card by the Nth-generation card, in order to generate a descendent card successively inheriting the authentication from a first-generation card as an ancestor card authenticated by a root certificate authority.

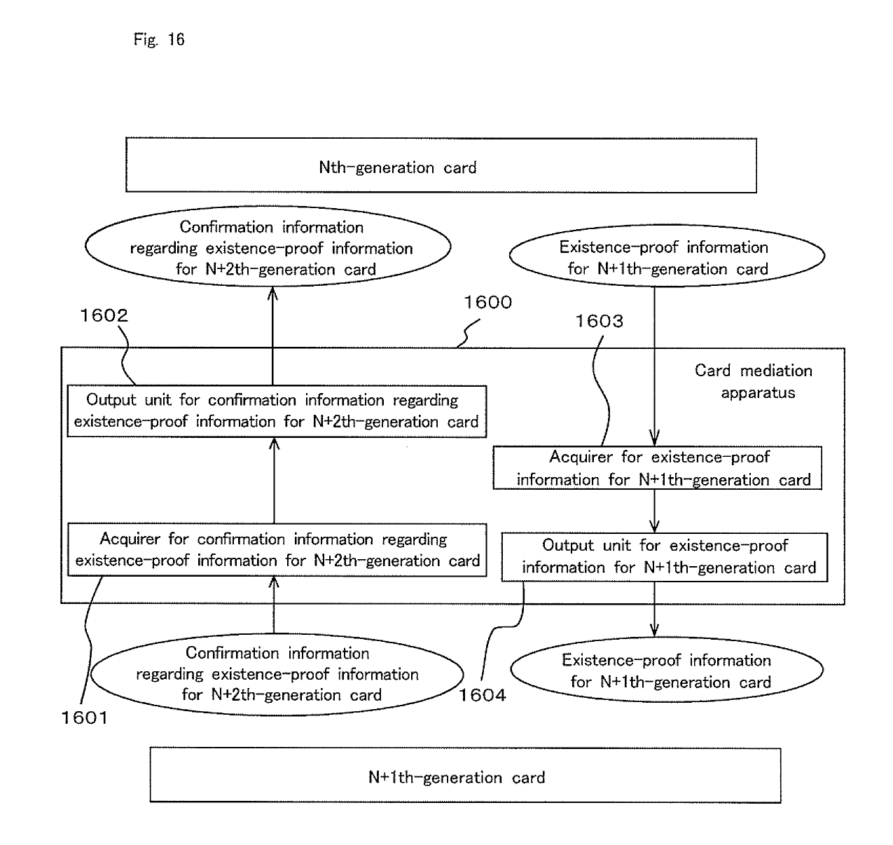

FIG. 16 is a functional block diagram of the card mediation apparatus of the ninth embodiment. The card mediation apparatus 1600 comprises the acquirer for confirmation information regarding existence-proof information for N+2th-generation card 1601, the output unit for confirmation information regarding existence-proof information for N+2th-generation card 1602, the acquirer for existence-proof information for N+1th-generation card 1603, and the output unit for existence-proof information for N+1th-generation card 1604.

The ‘acquirer for confirmation information regarding existence-proof information for N+2th-generation card’ 1601 acquires confirmation information regarding existence-proof information for N2th-generation card, which has one-to-one correspondence with the identity-proof information for N+1th-generation card of said N+1th-generation card, from said N+1th-generation card.

The ‘output unit for confirmation information regarding existence-proof information for N+2th-generation card’ 1602 outputs the confirmation information regarding existence-proof information for N+2th-generation card acquired by said acquirer for confirmation information regarding existence-proof information for N+2th-generation card 1601 to said Nth-generation card

The ‘acquirer for existence-proof information for N+1th-generation card’ 1603 acquires existence-proof information for N+1th-generation card outputted by said Nth-generation card in accordance with the confirmation information regarding existence-proof information for N+1th-generation card outputted by said output unit for confirmation information regarding existence-proof information for N+2th-generation card 1602.

The ‘output unit for existence-proof information for N+1th-generation card’ 1604 outputs the existence-proof information for N+1th-generation card acquired by said acquirer for existence-proof information for N+1th-generation card 1603 to said N+1th-generation card.

Note that the output and acquisition of the information may be carried out in a contact or non-contact environment as described in the sixth embodiment.

Therefore, it is possible to configure the respective units as the components of the card mediation apparatus of the ninth embodiment by means of any one of hardware, software, or both hardware and software. For example, in cases where a computer is used, hardware consisting of a CPU, memory, bus, interface, peripheral devices etc., and software, operatable on the hardware, are used for implementing them. As the peripheral devices, it is preferable to use a card reader/writer for reading/writing information for a card.

Ahead of the series of processes, acquisition and output of information, by the card mediation apparatus, the process, in which the N+1th-generation card recognizes the existence of the Nth-generation card, and confirms that the communication partner is the Nth-generation card, may be carried out. This makes possible to prevent the N+1th-generation card from acquiring the invalid existence-proof information for card generated by the entity, which is not the Nth-generation card.

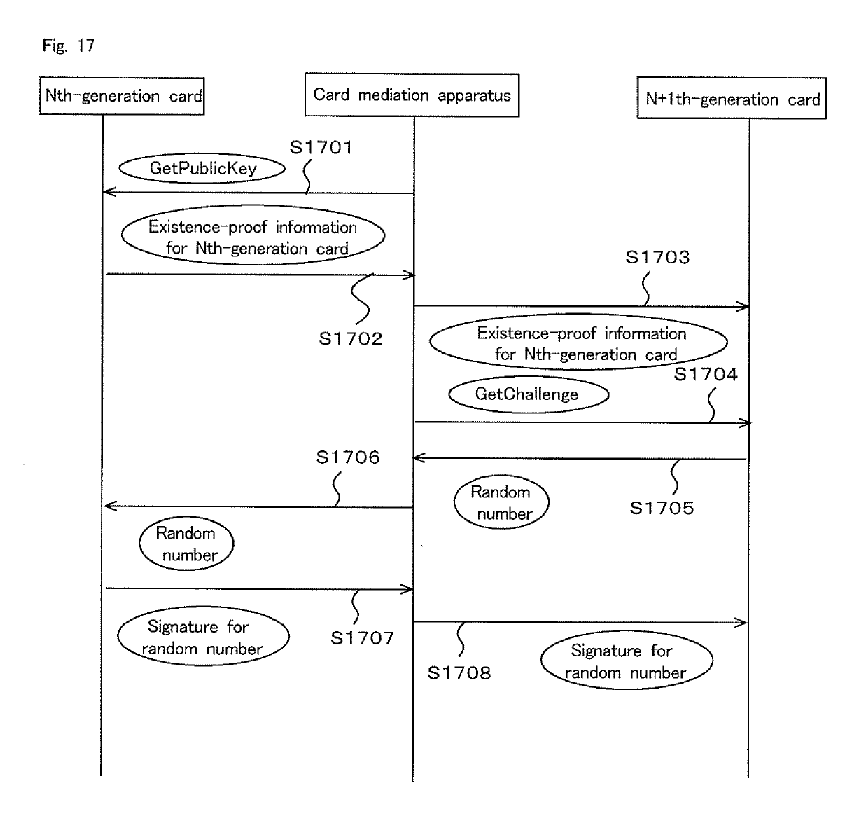

FIG. 17 is a sequential diagram of identification of existence of the Nth-generation card by the N+1th-generation card. Note that, in FIG. 17, it is assumed that the existence proof information for the Nth-generation card is the public key certificate of the Nth-generation card, and the identity-proof information for Nth-generation card is the secret key of the Nth-generation card. At the outset, in step S1701, the command to acquire the existence-proof information for the Nth-generation card is outputted from the card mediation apparatus to the Nth-generation card. The command name may be determined by standard etc., and in FIG. 17, the command is ‘GetPublicKey’. According to this command, in step S1702, the existence proof information for the Nth-generation card is outputted from the Nth-generation card to the card mediation apparatus. In step S1703, the existence proof information for the Nth-generation card is outputted from the card mediation apparatus to the N+1th-generation card. After that, in the N+1th-generation card, it is determined whether the existence-proof information for the Nth-generation card is authentic. Subsequently, in step S1703, the command to acquire random number is outputted from the card mediation apparatus to the N+1th-generation card. In FIG. 17, the command is ‘GetChallenge’ (the command name may be determined by standard etc.). According to this command, in the step S1705, the N+1th-generation card generates the random number, and outputs to the card mediation apparatus, and in step S1706, the card mediation apparatus outputs the random number to the Nth-generation card. The Nth-generation card gives signature in accordance with the identity-proof information for the Nth-generation card for the acquired random number, and in step S1706, outputs the signature for the random number to the card mediation apparatus. In step S1707, the card mediation apparatus outputs the signature for the random number to the N+1th-generation card. The N+1th-generation card determines whether the signature is authentic based on the existence-proof information for the Nth-generation card, and if the signature is authentic, it is confirmed that the communication partner of the N+1th-generation card is the Nth-generation card.

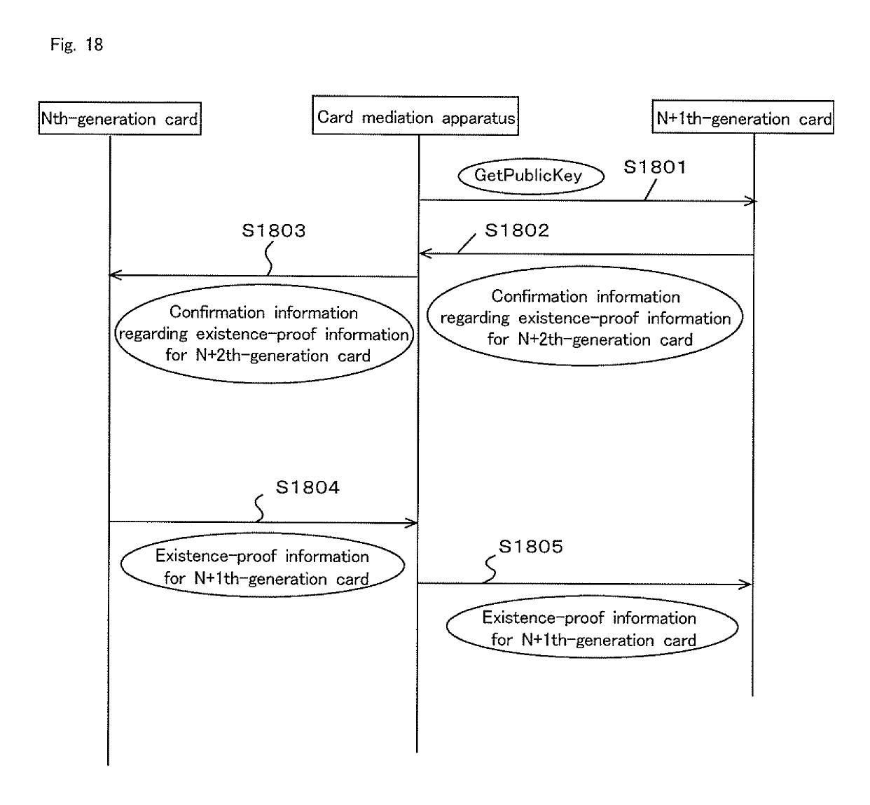

FIG. 18 is a sequential diagram of the process of the card mediation apparatus of the ninth embodiment. In step S1801, the card mediation apparatus outputs the command such as ‘GetChallenge’ to the N+1th-generation card in order to acquire the confirmation information regarding existence-proof information for N+2th-generation card, and in step S1802, acquires the confirmation information regarding existence-proof information for N+2-generation card from the N+1th-generation card by the acquirer for confirmation information regarding existence-proof information for N+2th-generation card 1601. In step S1803, the card mediation apparatus outputs the confirmation information regarding existence-proof information for N+2-generation card to the Nth-generation card by the output unit for confirmation information regarding existence-proof information for N+2-generation card 1602. In step SI804, the card mediation apparatus acquires the existence-proof information for N+1-generation card from the Nth-generation card by the acquirer for existence-proof information for N+1th-generation card 1603, and in step S1805, outputs the existence-proof information for N+1th-generation card to the N+1th-generation card by the output unit for existence-proof information for N+1th-generation card 1604.

According to the ninth embodiment, it becomes possible to mediate the Nth-generation card and the N+1th-generation card, thereby adding the N+1th-generation card to the parent-child card authentication system of the present application.

### Tenth Embodiment

As the tenth embodiment, the following parent-child card authentication method will be described. Therefore, the parent-child utilization system, in which a descendent card successively inheriting an authentication of a first-generation card as an ancestor card is generated and is utilized, wherein the Nth-generation card comprises the storage, which stores the identification information of parent card, the self-identification information, and the information, which is for managing the information indicating life cycle of itself based on the identification information of parent card, will be described.

The parent-child utilization system of the tenth embodiment is the utilization system, in which a descendent card successively inheriting an authentication of a first-generation card as an ancestor card is generated and is utilized.

The concept of the parent-child utilization system has been described with reference to FIG. 6. In the upper portion of FIG. 6, the tier of certificate authority is indicated. In the relationship of these certificate authorities, the certificate authority in the upper tier authenticates the certificate authority directly below. When a certain certificate authority authenticates the first-generation card, the card becomes the ancestor card, and the first-generation card authenticates the second-generation card. After that, in a similar manner, the N−1th-generation card authenticates the Nth-generation card. Thus, the terms ‘successively inheriting’ corresponds to that the N−1th-generation card authenticates the Nth-generation card.

In cases where the public key encryption carrying out encryption by means of public key and secret key is used, the signature by the secret key of the side, which carries out authentication, is given to the information including the public key of the side, which is to be authenticated, so that the public key certificate is generated, thereby implementing the above-mentioned authentication. For example, the signature by the secret key of the certificate authority is given to the information including the public key of the first-generation card, and similarly, the signature by the secret key of the N−1th-generation card is given to the information including the public key of Nth-generation card.

The process for generating the parent card and the child card, for example, the first-generation and second-generation card has been described with reference to FIG. 4. The parent card 405 as the first-generation card acquires the public key certificate for card 403 from the certificate authority 401 through the card issuer 402, and acquires the data 404 indicating the authority (e.g., credit card number, or application program for settlement) from the card issuer, and stores it, thereby generating the parent card 405.

Subsequently, the parent card 405 acquires the information including the public key from the child card 407, generates the public key certificate 406, and stores it in the child card 407. After that, the data indicating authority is acquired from the card issuer, and is stored.

Thus, the configuration, in which the parent card issues the public key certificate for card of the child card, provides the following effect; it becomes possible to examine which public key certificate for card issued by the parent card the child card has, so that it becomes possible to know that the parent card holder trusts the child card holder etc., thereby granting a part or all of the authority of the parent card holder to the child card holder without a reference check of the child card holder. For example, if the parent card is a credit card, it is possible to store the data for inheritance of a part or all of the credit of the parent card. In addition, if the parent card is an admission card to a specific room, it is possible to give an admission to the specific room to the child card holder.

The structure of the public key certificate for card has been described with reference to FIG. 8. The field 801 is information including the public key 805, and the signature for the information is stored in the field 807. Note that the field 807 of the signature including the data, which is acquired by encrypting, the field 805, hashed by MD5 (Message Digest Algorithm 5), by means of the secret key, is generated.

The serial number 802 is, for example, the sequential number for the public key certificate issued by the parent card. The issuer name 803 is the identification information of card (identification information of certificate authority) for identifying the parent card (or certificate authority), which has issued the public key certificate for the card. The subject name is the identification information of card for identifying the child card, of which the public key certificate for the card has been issued. The public key 805 is the public key of the card identified by the subject name. The extension 806 is the extension form. In this portion, for example, the value, which indicates whether the card having this public key certificate can generate the public key certificate of another card, or the value, which indicates up to what number of generations the card can generate, is stored. On the right side of FIG. 8, the structure of extension by X.509 format is exemplified. In the portion of CA (INTEGER type), the value, which indicates whether the card having this public key certificate can generate the public key certificate of another card as the certificate authority, is stored. In the portion of ‘pathLenConstraint’, the value, which indicates up to what number of generations the card can generate, is stored. Therefore, if the stored value is 0, it is impossible to generate die public key certificate of another card, Alternatively, if the stored value is positive, the value, which is acquired by subtracting 1 from the stored value, is stored in the public key certificate of card, which is to be generated.

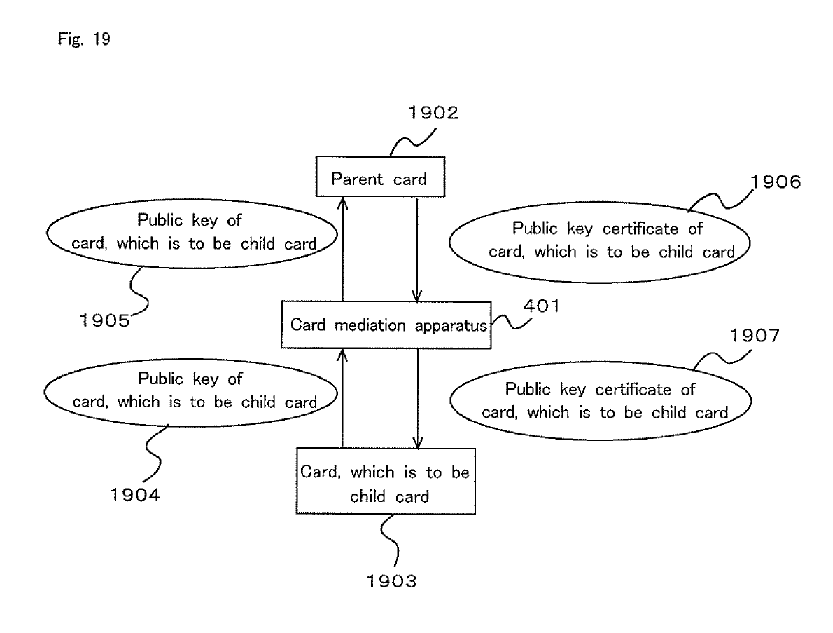

FIG. 19 is a block diagram of the mediation apparatus generating the child card from the parent card. When the parent card 1902 and the card 1903, which is to be a child card, are attached to the card mediation apparatus 1901, the public key 1904 of the card, which is to be a child card, is outputted from the card 1903, which is to be child card, to the card mediation apparatus 1901, and the public key 1905 of the card, which is to be a child card, is outputted from the card mediation apparatus 1901 to the card, which is to be a parent card. Note that the information outputted from the card mediation apparatus 1901 to the card, which is to be a parent card, is not limited to the public key 1905 of the card, which is to be a child card, and may be the value specification of the portion of extension etc. When the public key certificate of the card, which is to be a child card, is generated in the parent card 1902, it is outputted to the card 1903, which is to be a child card, through the card mediation apparatus 1901, and is stored, thereby generating the child card of the parent card 1902.

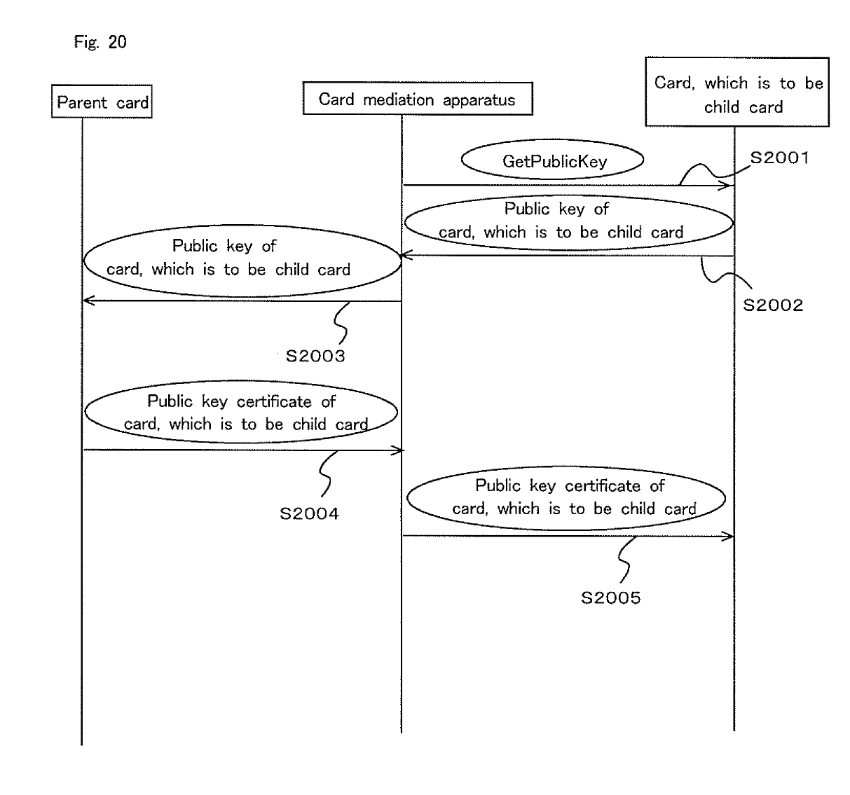

FIG. 20 is a sequential diagram of data exchange between the card mediation apparatus, the parent card, and the card, which is to be a child card. In step S2001, the command to acquire the public key is outputted from the card mediation apparatus to the card, which is to be a child card. As to the name of the command, for example, ‘GetPublicKey’, is used, and depending on the specification of the card, another name may be used. In step S2002, according to step S2001, the public key of the card, which is to be a child card, is outputted to the card mediation apparatus. In step S2003, the public key of the card, which is to be a child card, is outputted to the parent card, thereby generating the public key certificate of card in the parent card. In step S2004, the public key certificate of the card, which is to be a child card, is outputted to the card mediation apparatus, and is outputted to the card, which is to be child card, in step S2005.

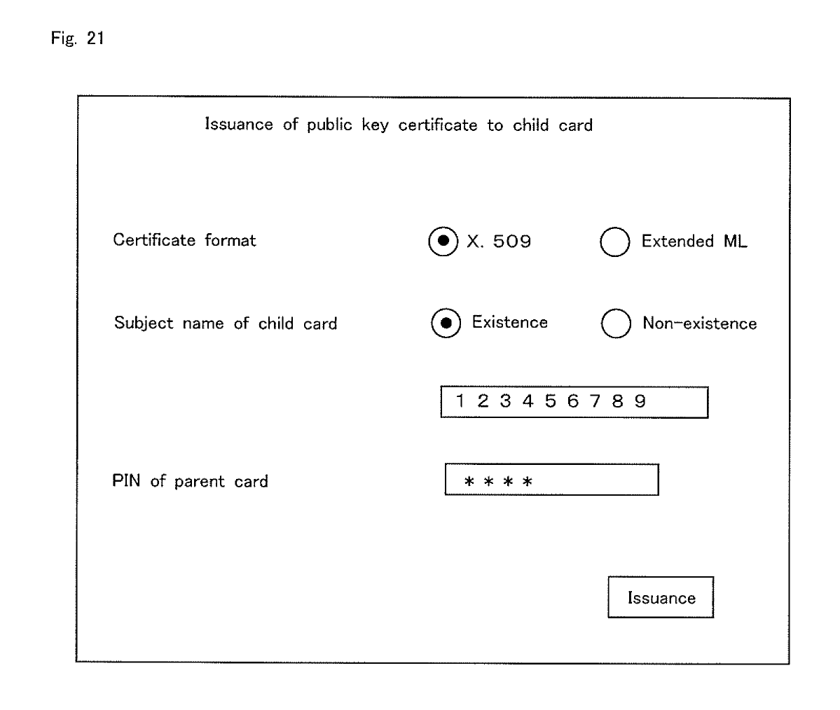

FIG. 21 is a diagram exemplifying a screen upon operation of the card mediation apparatus. By means of this screen, the format of the public key certificate of card, and the subject name of child card are inputted. Further, the PIN information for authenticating the parent card holder is also inputted. The information inputted by means of this screen with the public key of the card, which is to be a child card, is outputted from the card mediation apparatus to tie parent card. Note that it is possible to configure the respective units as the components of the card mediation apparatus by means of any one of hardware, software, or both hardware and software. For example, in cases where a computer is used, hardware consisting of a CPU, memory, bus, interface, peripheral devices etc., and software, opera table on the hardware, are used for implementing them. In addition, it is possible to record such software (program) to a medium such as an optical disk.

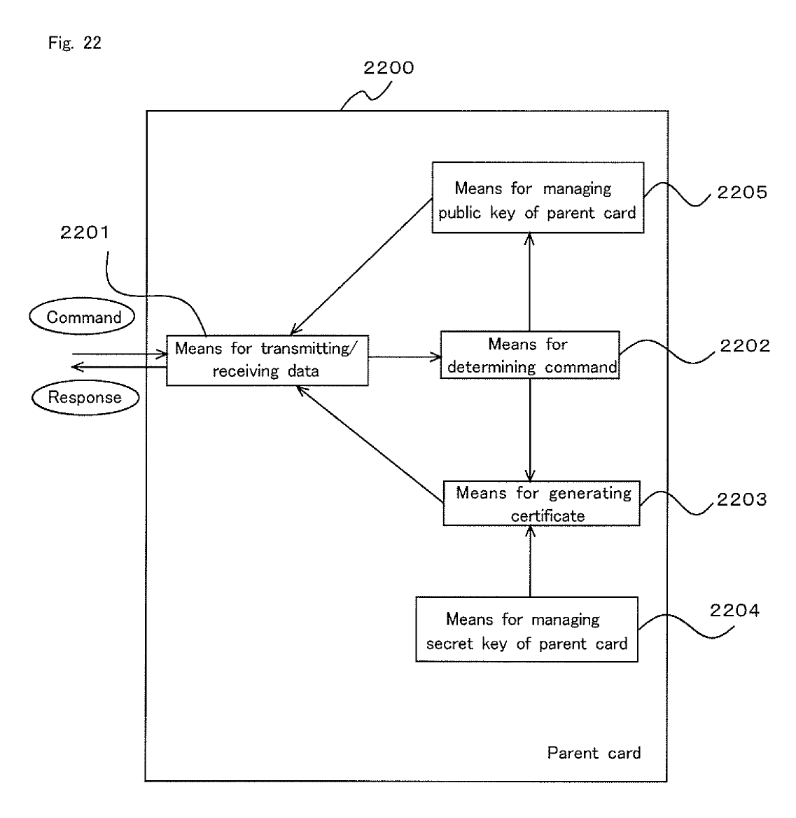

FIG. 22 is a functional block diagram of the parent card. The means for transmitting/receiving data 2201 is an interface for inputting the command for the parent card 2200 and for outputting the response for the command. The command inputted by the means for transmitting/receiving data 2201 is determined by the means for determining command 2202, and activates appropriate means, thereby generating the response. The means for generating certificate 2203 is a means for generating the public key certificate of card, and gives the signature for the information including the public key by means of the secret key of the parent card stored by the means for managing secret key of parent card 2204. The means for managing public key of parent card 2205 is a means for storing the public key corresponding to the secret key of the parent card stored by the means for managing secret key of parent card 2204, and performs upon inputting the command to output the public key of parent card.

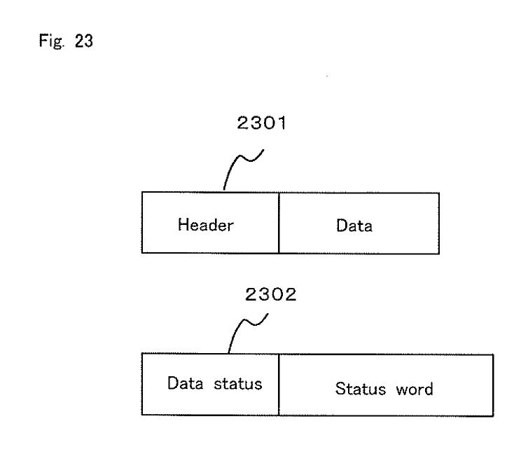

FIG. 23 is a diagram showing format of command and response. The command 2301 consists of the header portion and the data portion as shown in FIG. 23. In the header portion, the type of command is stored, and in the data portion, data necessary for processing of the command is stored. For example, in the case of the command to generate the public key certificate of the card, the public key and the information inputted to the screen shown in FIG. 21 are stored in the data portion. The response 2301 consists of the data portion and the status word portion as shown in FIG. 23. In the data portion, the data to be returned as a response is stored, and in the status word portion, the value indicating whether the command is successfully carried out is stored. For example, in the case of the command to generate the public key certificate of the card, the public key certificate of card is stored in the data portion, and the value indicating whether the public key certificate of card is successfully generated. For example, the value indicating that the PIN information is incorrect and the public key certificate of card has not been generated.

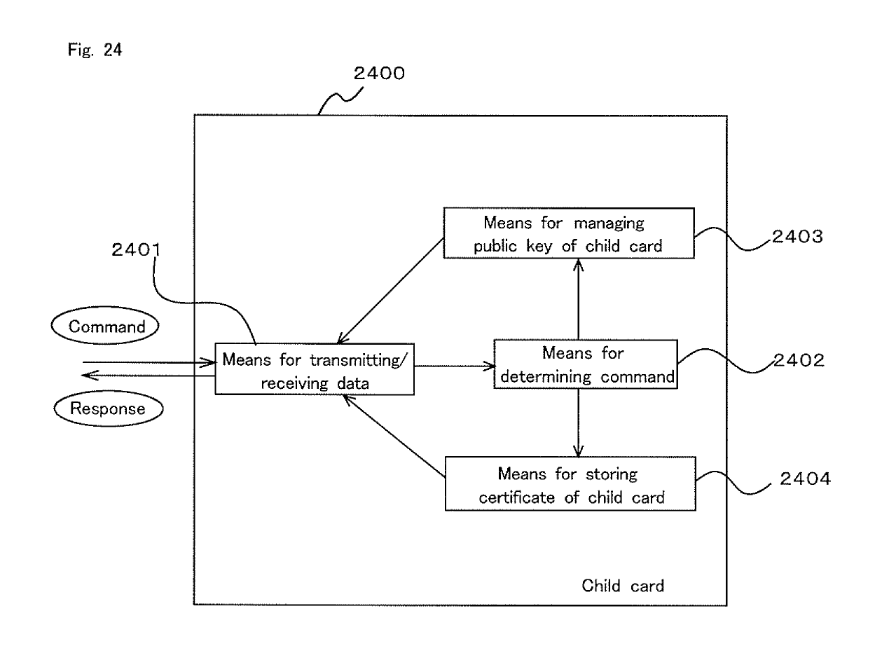

FIG. 24 is a functional block diagram of the child card, Similarly to the parent card, the means for transmitting/receiving data 2401 is an interface for inputting the command for the child card 2400 and for outputting the response for lie command. The command inputted by the means for transmitting/receiving data 2401 is determined by the means for determining command 2402, and activates appropriate means. The child card 2403 is a means for storing the public key of die child card. For example, in cases where the command is ‘GetPublicKey’, the public key is returned as a response. The means for storing certificate of child card 2404 is a means for storing the public key certificate of card.

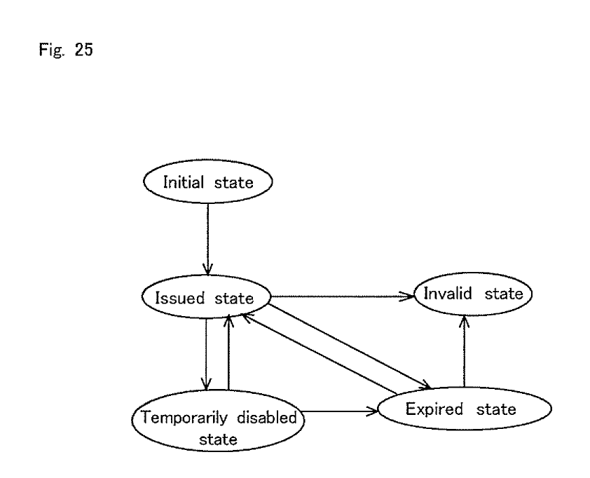

FIG. 25 is a transition diagram exemplifying the state of life cycle of a card. Examples of the state of life cycle of a card include the initial state, the issued state, the temporarily disabled state, the expired state, and the invalid state. Immediately after the card is manufactured, it is in the initial state, and when it is issued, it goes into the issued state. If the card is unusable for some reason, it goes into the temporarily disabled state, and when the reason is resolved, it returns to the issued state. Further, if the card is expired, it goes into the expired state, and becomes unusable. If the operation to extend the expiration date is carried out, the card goes into the issued state. Further, if the card once issued is discarded, it goes into the invalid state.

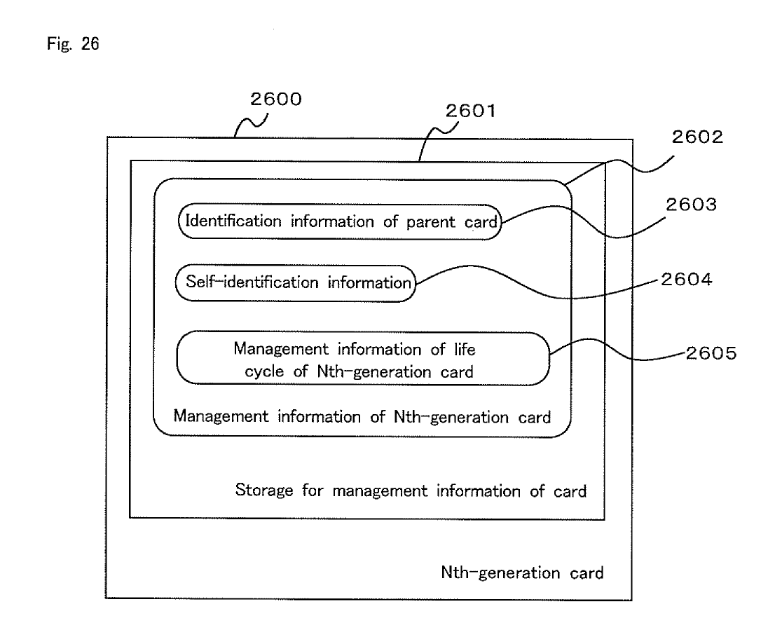

FIG. 26 is a functional block diagram of the Nth-generation card of the parent-child card utilization system of the tenth embodiment. The Nth-generation card comprises the storage for management information of card 2601. Although there are units and means necessary for operation of the card other than the storage for management information of card 2601, they will be omitted.

The ‘storage for management information of card’ 2601 stores the management information of Nth-generation card. For example, it stores the management information of card in the memory area equipped with the Nth-generation card. Here, the term ‘store’ means to record for a certain period of time in the readable state.

The ‘management information of Nth-generation card’ is information including the identification information of parent card 2603, the self-identification information 2604, and the management information of life cycle of Nth-generation card 2605. Here, the ‘identification information of parent card’ is identification information of card for identifying the parent card as the N−1th-generation card, For example, it is the value stored as the issuer name 803 included in the public key certificate, of which structure has been exemplified in FIG. 8. The ‘self-identification information’ is identification information of card for identifying the child card itself as the Nth-generation card. For example, it is the value stored as the subject name 804.

The ‘information of life cycle of Nth-generation card’ is information for managing the state information of life cycle of the Nth-generation card based on the identification information of parent card. Here, the ‘state information of life cycle of Nth-generation card’ is information, which indicates the life cycle of child card as the Nth-generation card. For example, the state information of life cycle of Nth-generation card indicates the information indicating the state such as ‘initial state’, ‘issued state’, ‘temporarily disabled state’, ‘expired state’, or ‘invalid state’. Further, the terms ‘managing based on the identification information of parent card’ corresponds to a concept including generation of the state information of life cycle of Nth-generation card in conjunction with the life cycle of the parent card acquired based on the identification information of the parent card.

Examples of the information of life cycle of Nth-generation card include ‘synchronization’, ‘complementation’, ‘reproduction’, and ‘independence’. The ‘synchronization’ is to synchronize the life cycle of the child card with the life cycle of the parent card. Therefore, if the parent card is usable, the child card becomes usable. The ‘complementation’ is to make the life cycle of the child card different from the life cycle of the parent card. For example, if the parent card goes into the disabled state, the child card becomes usable, or if the parent card becomes usable, the child care goes into the disabled state. The ‘reproduction’ is the information of the life cycle of Nth-generation card, which indicates that if the parent card goes into the disabled state, the child card goes into the temporarily disabled state (life cycle), and stays in the temporarily disabled state until the new public key certificate for card is issued for the parent card. The ‘independence’ indicates the case that the life cycle of the child card does not depend on the life cycle of the parent card. If the parent card goes into the disabled state from the state, in which both parent card and child card are usable, the child card remains to be usable.

An example of the case of the ‘synchronization’ is as follows. In cases where the child card is generated from the admission card as the parent card held by a certain staff, and the parent card becomes invalid due to the staff's retirement or relocation, the child card is invalidated. Further, an example of the case of the ‘complementation’ is as follows. In cases where a copy of a credit card as the parent card is generated as the child card, and the parent card is lost and is invalidated, the child card is disabled. Although the change for card occurs just once in this case, there are cases in which multiple changes are possible, for example, when a card is necessary in order to access the company data, and subordinates use child cards on behalf of their boss having a parent card, or when a limitation on the number of changes is set. An example of the case of the ‘reproduction’ includes the parent-child card used in a company organization. For example, if a boss holds the parent card, a subordinate holds the child card, and a new boss comes due to relocation, the child card held by the subordinate is temporarily disabled until the public key certificate for card is newly issued to the new boss, and the public key certificate for the child card is reissued by the boss's card. Therefore, the child card of the subordinate goes into the temporarily disabled state until the parent card of the new boss becomes valid. Alternatively, if the public key certificate for parent card of the boss is expired, the child card of the subordinate goes into the temporarily disabled state until the public key certificate for parent card is renewed. Therefore, the child card of the subordinate goes into the temporarily disabled state until the parent card of the boss becomes valid, so that it becomes possible to prevent the confidential information of company from being leaked due to an unauthorized act by a subordinate during the absence of their boss.

The information of life cycle of Nth-generation card can be stored in the extension portion of the public key certificate for card, and the information of life cycle of Nth-generation card, which is to be stored, can be specified, for example, by means of the screen upon using the card mediation apparatus. Therefore, the Nth-generation card acquires the public key certificate for card from the N−1th-generation card as the parent card, the means for storing the public key certificate for card (e.g., the means for storing certificate for child card in FIG. 24) corresponds to the storage for management information of card of the tenth embodiment. Alternatively, the identification information of parent card, the self-identification information, and the management information of life cycle of Nth-generation card may be extracted from the public key certificate for card, and may be stored in the different field from the field in which the public key certificate for card is stored.

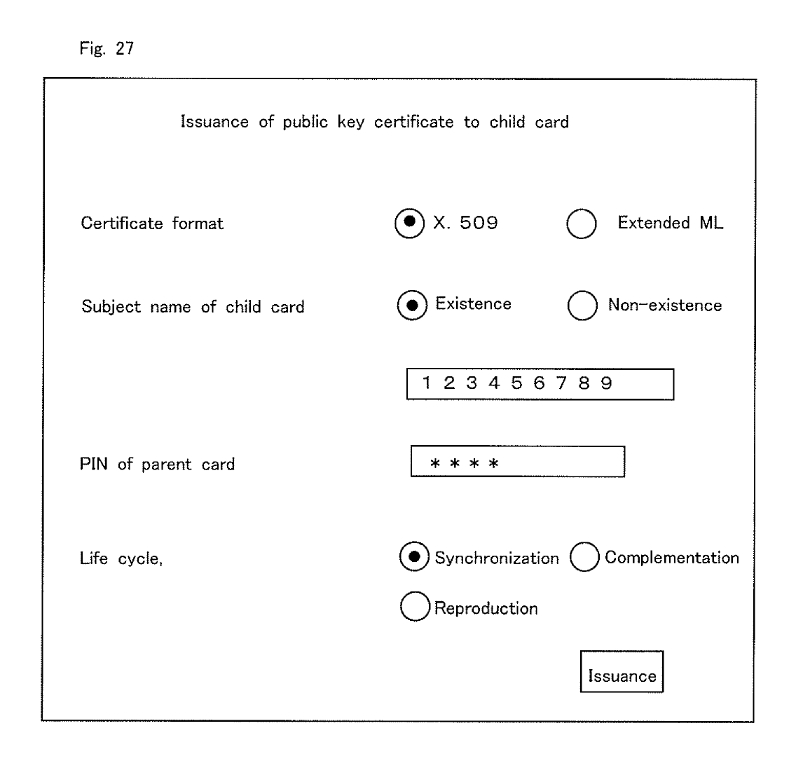

FIG. 27 is a diagram exemplifying a screen upon operation of the card mediation apparatus. Although FIG. 24 exemplifies the screen, the difference from FIG. 21 is that ‘specification of life cycle’ is indicated in FIG. 27, thereby enabling selection of ‘synchronization’, ‘complementation’, or ‘reproduction’ etc.

Therefore, in cases where the Nth-generation card is the parent card, the Nth-generation card may comprise the unit for acquiring the management information of life cycle of N+1th-generation card specified by the specification of life cycle.

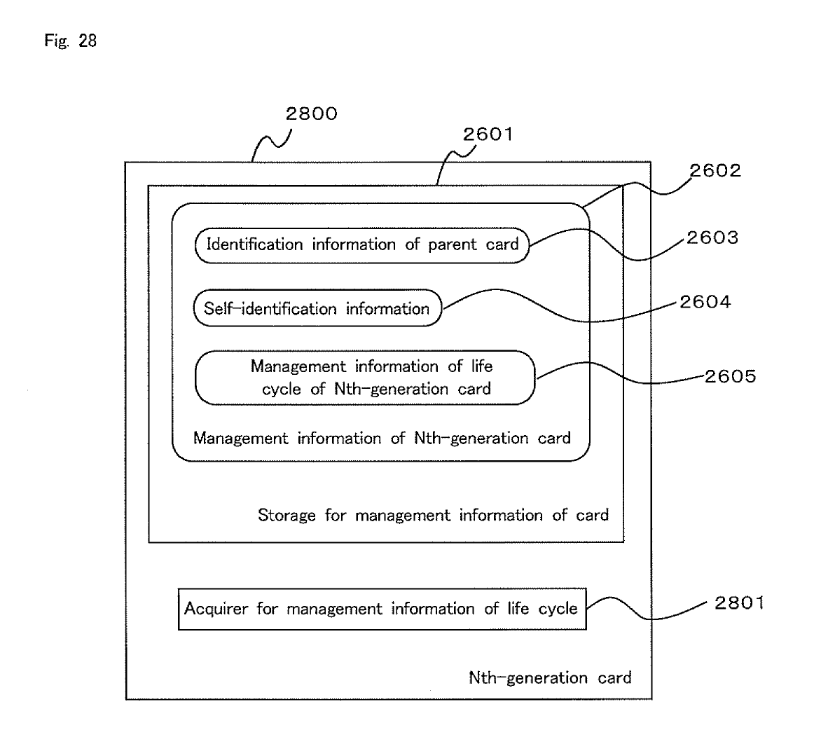

FIG. 28 is a functional block diagram of the Nth-generation card acquiring the management information of life cycle of N+1th-generation card. The acquirer for management information of life cycle 2801 is added to the functional block diagram exemplified in FIG. 26.

The ‘acquirer for management information of life cycle’ 2801 acquires the management information of life cycle of N+1th-generation card. Note that the ‘management information of life cycle of N+1th-generation card’ is management information of life cycle to be stored by the storage for management information of card in the N+1th-generation card. Therefore, it is used as a unit when the Nth-generation card becomes the parent card and the N+1th-generation card as the child card is generated.

According to the tenth embodiment, the identification information of parent card, the self-identification information, and the management information of life cycle of Nth-generation card are stored as the management information of Nth-generation card in the Nth-generation card, so that it becomes possible to manage the management information of life cycle of Nth-generation card based on the life cycle of the Nth-generation card as the parent card identified by the identification information of parent card. In addition it becomes possible to generate the Nth-generation card storing the specified management information of life cycle of Nth-generation card.

### Eleventh Embodiment

As the eleventh embodiment, the parent-child utilization system according to the tenth embodiment, which further comprising the server for state information of life cycle, will be described.

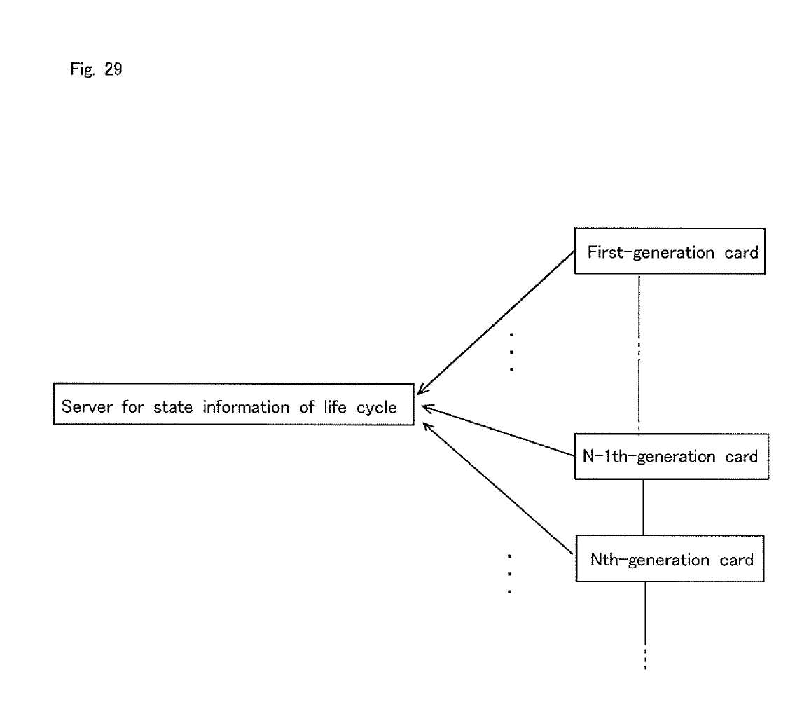

FIG. 29 is a block diagram of the server for state information of life cycle. As shown on the right side portion of FIG. 29, there are descendant cards, which successively inherit authentication from the first-generation card as an ancestor card, such as the second-generation card, the third-generation card, . . . , the N−1th-generation card, and the Nth-generation card. In this case, respective cards request authentication for receiving service to the server for state information of life cycle. For example, if the card is for admission, the server for state information of life cycle confirms whether the card successively inherits authentication from the first-generation card. Therefore, the public key certificate of the parent card of the card is acquired by means of a directory server etc., and it is determined whether the signature of the public key certificate is given by the parent card. Subsequently, the public key certificate of the grandparent card is acquired, and the signature of the public key certificate is examined. Thus, the ancestor card of the parent card is searched, so that it is determined whether it is possible to reach to the first-generation card. Moreover, in addition to the determination as to whether the card successively inherits authentication, the server for state information of life cycle acquires the life cycle based on the life cycle of the parent card of the card.

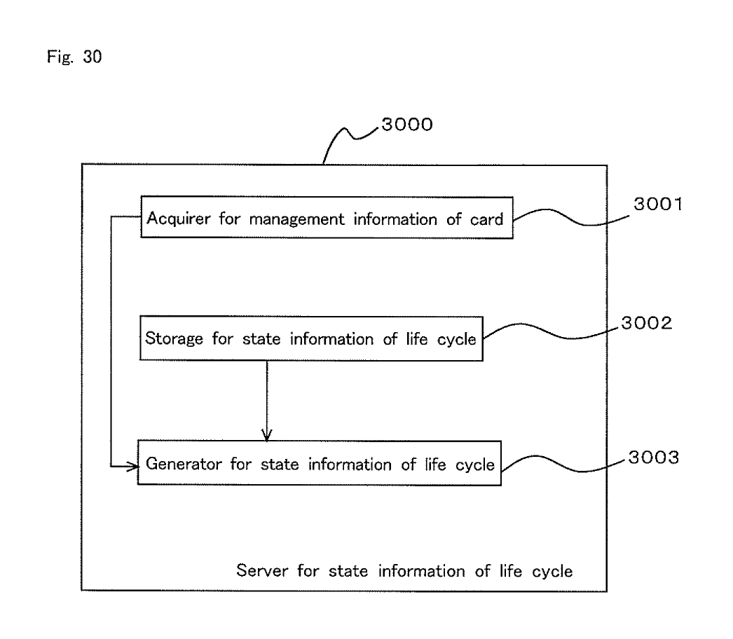

FIG. 30 is a functional block diagram of the server for state information of life cycle of the eleventh embodiment.

The ‘server for state information of life cycle’ 3000 comprises the acquirer for management information of card 3001, the storage for state information of life cycle 3002, and the generator for state information of life cycle 3003.

The ‘acquirer for management information of card’ 3001 acquires the management information of Nth-generation card from the Nth-generation card requesting an authentication. Therefore, the command to output the management information of Nth-generation card as a response to the Nth-generation card is outputted to the Nth-generation card, and the response is acquired.

The ‘storage for state information of life cycle’ 3002 stores state information of life cycle correlated with identification information of card, in which the state information of life cycle indicates state of life cycle of a card identified by the identification information of card. The ‘state information of life cycle’ is information indicating the state of life cycle. For example, it is the information indicating ‘issued state’, ‘temporarily disabled state’, ‘expired state’, or ‘invalid state’ etc. Alternatively, it may be the information indicating that the life cycle is unknown. In the storage for state information of life cycle 3002, the identification information of card, and the state information of life cycle of card identified by the identification information of card may be correlated and stored in the readable state, changeable state, or state that new value can be insert, in the form of table managed by a relational database etc.

The ‘generator for state information of life cycle’ 3003 generates state information of life cycle of said Nth-generation card requesting the authentication, based on state information of life cycle of N−1th-generation card, which is acquired from said storage for state information of life cycle 3002 based on the identification information of parent card included in the management information of Nth-generation card acquired by said acquirer for management information of card 3001, and on the management information of life cycle of Nth-generation card included in the management information of Nth-generation card acquired by said acquirer for management information of card 3001. If in the storage for state information of life cycle 3002, the identification information of card, and the state information of life cycle of card identified by the identification information of card are correlated and stored in the form of a table managed by a relational database, the state information of life cycle of parent card is acquired by searching the table by means of the identification information of parent card, and the state information of life cycle of Nth-generation card is acquired based on the management information of life cycle of Nth-generation card. If the management information of life cycle of Nth-generation card indicates ‘synchronization’, the state information of life cycle same as that of the parent card is set, and if ‘complementation’ is indicated, the state information of life cycle, which indicates different availability from that of the state information of life cycle of parent card, is set. Further, the state information of life cycle of parent card is unknown, the state information of life cycle of grandparent card is searched for, therefore, the ancestor card of the parent card is searched for, so that the state information of life cycle of parent card may be determined.

Note that it is possible to configure the respective units as the components of the card mediation apparatus by means of any one of hardware, software, or both hardware and software. For example, in cases where a computer is used, hardware consisting of a CPU, memory, bus, interface, peripheral devices etc., and software, opera table on the hardware, are used for implementing them. In addition, it is possible to record such software (program) to a medium such as an optical disk,

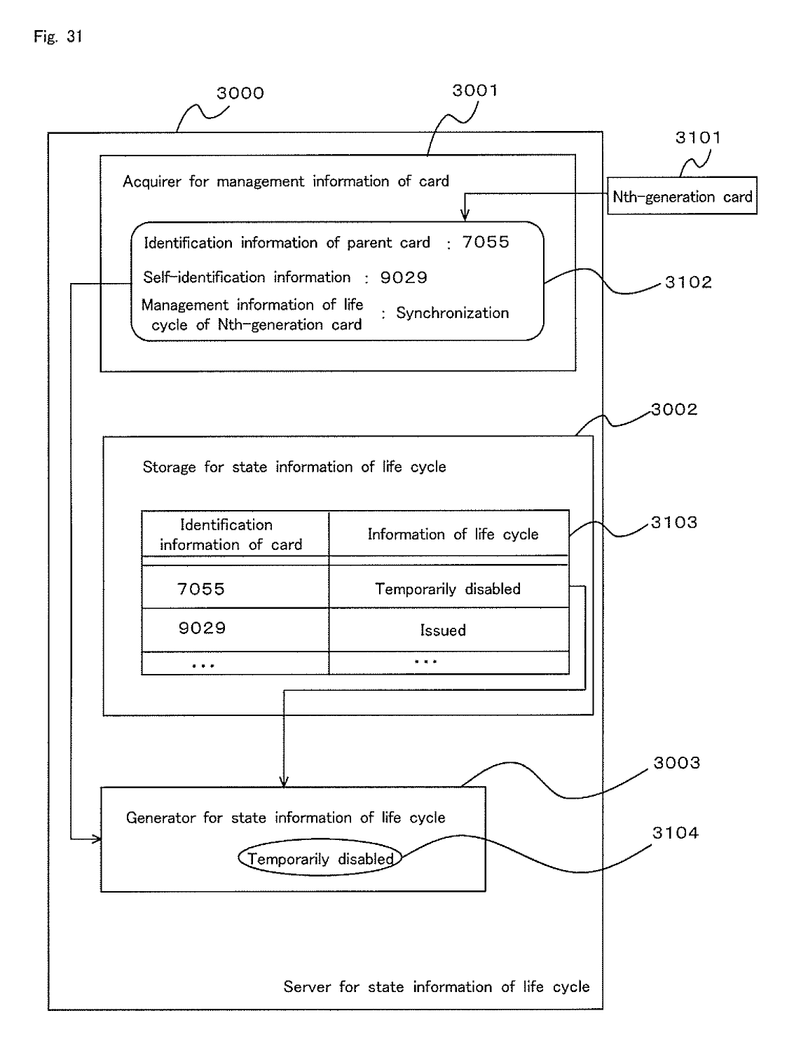

FIG. 31 is a diagram exemplifying operation of the server for state information of life cycle. The acquirer for management information of card 3001 acquires the management information of Nth-generation card 3102 of the Nth-generation card 3101. Moreover, in the storage for state information of life cycle 3002, the identification information of card, and the state information of life cycle of card identified by the identification information of card are correlated and stored by means of the table 3103 having the column of the identification information of card, and of the state information of life cycle of card. Concretely explaining, 7055, the identification information of card, is correlated with the state information of life cycle indicating ‘temporarily disabled state’, Since the 7055 is the identification information of parent card included in the management information of Nth-generation card 3102, the generator for state information of life cycle 3003 acquires the ‘temporarily disabled state’ as the state information of life cycle of parent card. Then, since the management information of life cycle of Nth-generation card indicates ‘synchronization’, the ‘temporarily disabled state’ as the state information of life cycle of Nth-generation card is generated.

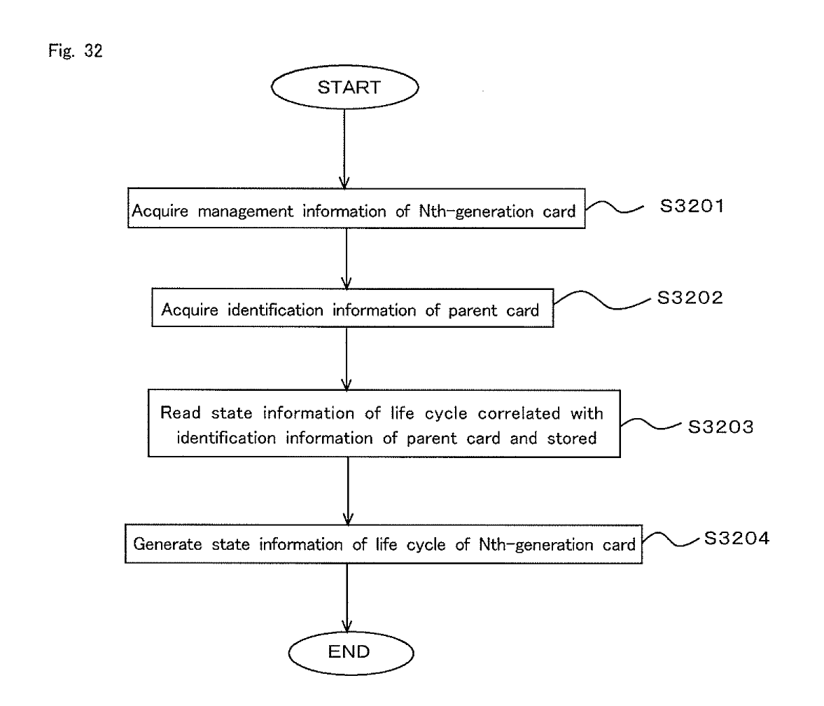

FIG. 32 is a flow chart of processing of the server for state information of life cycle. In step S3201, the management information of the Nth-generation card requesting authentication is acquired by the acquirer for management information of card 3001. In step S3202, the generator for state information of life cycle 3003 acquires the identification information of parent card from die management information of Nth-generation card. In step S3303, the state information of life cycle correlated with the identification information of parent card and stored is read from the information stored by the storage for state information of life cycle 3002. In step S3204, the state information of life cycle of Nth-generation card is generated based on the management information of life cycle of Nth-generation card.

According to the eleventh embodiment, it becomes possible to generate and to manage the state information of life cycle of the card requesting authentication.

### Twelfth Embodiment

As the twelfth embodiment, the parent-child utilization system, wherein the server for state information of life cycle changes the state information of life cycle, which has been correlated with the identification information of said Nth-generation card, and stored by said storage for state information of life cycle, if the state information of life cycle generated by said generator for state information of life cycle indicates that said Nth-generation card requesting the authentication is unusable.

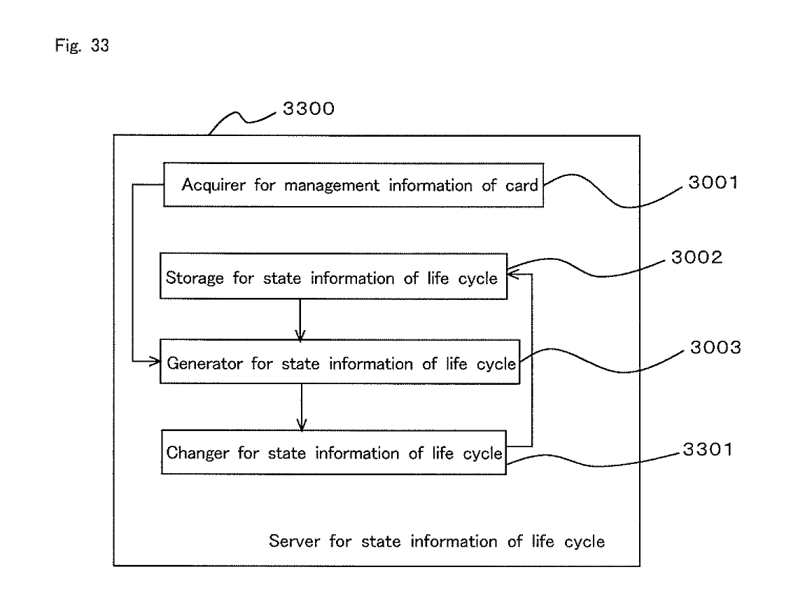

FIG. 33 is a functional block diagram of the server for state information of life cycle of the parent-child utilization system of the twelfth embodiment, The server for state information of life cycle 3300 comprises the acquirer for management information of card 3001, the storage for state information of life cycle 3002, the generator for state information of life cycle 3003, and the changer for state information of life cycle 3301, Therefore, the server for state information of life cycle of the twelfth embodiment is the server for state information of life cycle further comprising the changer for state information of life cycle 3301.

The ‘changer for state information of life cycle’ 3301 changes the state information of life cycle, which has been correlated with the identification information of said Nth-generation card, and stored by said storage for state information of life cycle 3002, if the state information of life cycle of card generated by said generator for state information of life cycle 3303 indicates that said Nth-generation card requesting the authentication is unusable, Therefore, in cases where the storage for state information of life cycle 3002 manages the identification information, and the state information of life cycle in the form of a table managed by a relational database, the state information of life cycle of the Nth-generation card requesting authentication is renewed. Concretely speaking, in the case of FIG. 31, the value in the column of the state information of life cycle on the line of the card identifier 9029 is temporarily disabled.

In the processing of the server for the state information of life cycle of the twelfth embodiment, after step S3204 shown in FIG. 32, the changer for state information of life cycle 3301 determines whether the generated state information of life cycle indicates unusable, and if so, change is carried out.

According to the twelfth embodiment, when it is determined that the card is unusable, the state information of life cycle stored by the server for state information of life cycle is changed to the disabled state, so that the card is disabled, and for example, it becomes possible to maintain the security when the card is used for management of entering the room.

### Thirteenth Embodiment

As the thirteenth embodiment, the parent-child utilization system, which comprises the server for state information of life cycle, which outputs a command, which disables said Nth-generation card, if the state information of life cycle of card generated by said generator for state information of life cycle indicates that said Nth-generation card requesting the authentication is unusable, will be described.

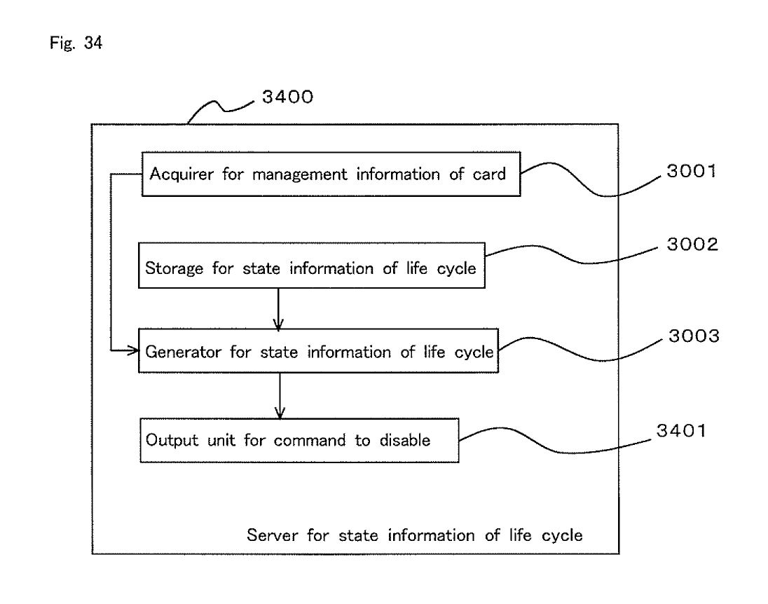

FIG. 34 is a functional block diagram of the server for state information of life cycle of the thirteenth embodiment. The server for state information of life cycle 3400 comprises the acquirer for management information of card 3001, the storage for state information of life cycle 3002, the generator for state information of life cycle 3003, and the output unit for command to disable 3401. Therefore, the server for state information of life cycle of the thirteenth embodiment is the server for state information of life cycle according to the eleventh embodiment comprising the output unit for command to disable 3401.

The ‘output unit for command to disable’ 3401 outputs a command, which disables said Nth-generation card, if the state information of life cycle of card generated by said generator for state information of life cycle 3003 indicates that said Nth-generation card requesting the authentication is unusable. The name of command is determined by the specification of the card and is optionally set, In addition, the command to disable may include the information for certifying that the apparatus, which has outputted the command, has the authority, in the data portion of the command. In addition, the command to disable may be implemented by multiple exchanges of command and response. For example, the public key certificate of the server for state information of life cycle is outputted from the server for state information of life cycle to the card, the card generates the random number, the server for state information of life cycle encrypts the random number by the secret key, and outputs it to the card. The card carries out decryption by the public key included in the public key certificate, determines whether the value same as the generated random number is acquired, and accepts the command to disable after authenticating the server for state information of life cycle.

In addition, the Nth-generation card, which has accepted the command to disable, may completely stop operation, and may be in a disabled state after that. Alternatively, it may not accept excluding a specific command to enable again.

In the processing of the server for the state information of life cycle of the thirteenth embodiment, after step S3204 shown in FIG. 32, the output unit for command to disable 3401 outputs a command, which disables said Nth-generation card, if the state information of life cycle of card generated by said generator for state information of life cycle 3003 indicates that said Nth-generation card requesting the authentication is unusable.

According to the thirteenth embodiment, when it is determined that the card is disabled, the card is disabled, so that it becomes possible to prevent the data stored in the card from leaking etc.

### Fourteenth Embodiment

As the fourteenth embodiment, the parent-child utilization system, which comprises the server for state information of life cycle, which outputs request information for disabling, which is for requesting other server to output a command to disable said Nth-generation card, if the state of life cycle generated by said generator for state information of life cycle indicates that said Nth-generation card requesting the authentication is unusable, will be described.

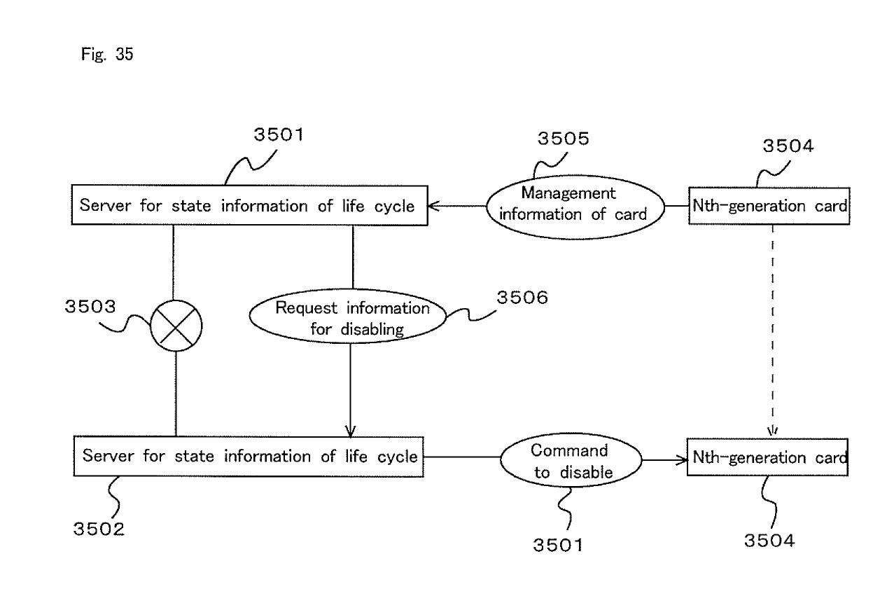

FIG. 35 is a block diagram of the fourteenth embodiment. It is assumed that the server for state information of life cycle 3501 is in communicable state with the other server for state information of life cycle 3502 via the communication line 3503, and the Nth-generation card 3504 requests the authentication to the server for state information of life cycle 3501, and outputs the management information of card 3505. In this case, if the server for state information of life cycle 3501 generates the state information of life cycle of the Nth-generation card 3504 indicating that the card is disabled, the output of the command to disable is requested to the other server for state information of life cycle 3502. After that, the server for state information of life cycle 3501 performs as a relay point for transmitting the command to disable 3501 outputted from the server for state information of life cycle 3502 to the Nth-generation card 3504. Alternatively, if the Nth-generation card 3504 requests the authentication to the server for state information of life cycle 3502, the command to disable 3507 for disabling is outputted to the Nth-generation card 3504.

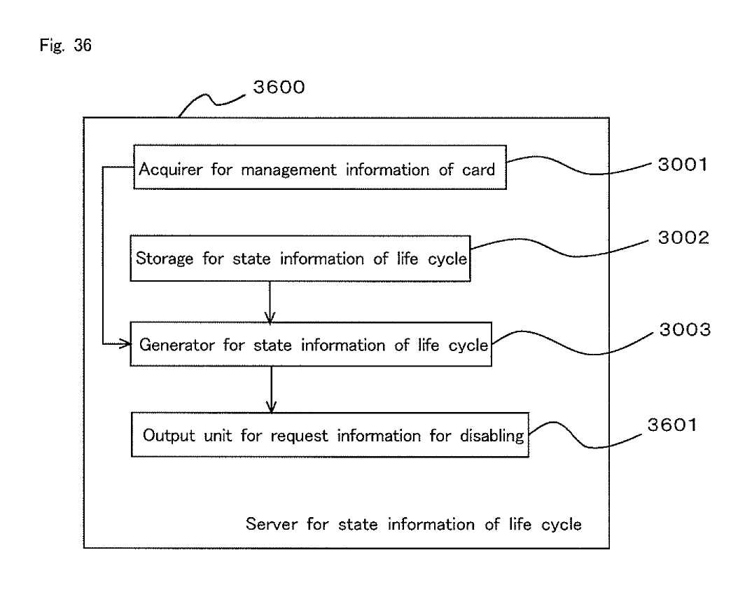

FIG. 36 is a functional block diagram of the server for state information of life cycle of the fourteenth embodiment. The server for state information of life cycle 3600 comprises the acquirer for management information of card 3001, the storage for state information of life cycle 3002, the generator for state information of life cycle 3003, and the output unit for request information for disabling 3601. Therefore, the server for state information of life cycle of the fourteenth embodiment is the server for state information of life cycle according to the eleventh embodiment comprising the output unit for request information for disabling 3601.

The ‘output unit for request information for disabling’ 3601 outputs request information for disabling, if the state information of life cycle of card generated by said generator for state information of life cycle 3003 indicates that said Nth-generation card requesting the authentication is unusable. Here, the ‘request information for disabling’ is information for requesting other server to output a command to disable said Nth-generation card. This request information for disabling may be transmitted to respective servers, which is communicable with the card (including the server for state information of life cycle), or may be broadcasted on the network, to which the server communicable with the card is connected. Alternatively, in cases where the request information for disabling is outputted to a central server, which manages the disabled card, and the card requests authentication to the server communicable with the card, the server may carry out querying to the central server, and may determine whether the command to disable is to be outputted.

In the processing of the server for the state information of life cycle of the fourteenth embodiment, after step S3204 shown in FIG. 32, the output unit for request information for disabling 3601 determines whether the generated state information of life cycle indicates unusable, and if so, the request information for disabling is outputted

According to the fourteenth embodiment, for example, even if the server for the state information of life cycle gets overloaded, it takes a long time to generate the state information of life cycle of the Nth-generation card requesting authentication, thereby causing a time-out error, and disabling communication with the Nth-generation card before completing the generation, it becomes possible to request for outputting die command to disable to the other server, thereby preventing the data stored in the card from leaking etc. In addition, it becomes possible to restrict the owner of the server for changing state of life cycle, which is a server having authority to change the state information of life cycle of card, to the card issuer. Consequently, the card issuer can integrately manage the state information of life cycle of card. In this case, the server for state information of life cycle outputs the request information for disabling to the server for changing state of life cycle owned by the card issuer. Further, in cases where the server for changing state of life cycle is not communicable, the other server for state information of life cycle may perform as a relay point for the request information for disabling to the server for changing state of life cycle.

### INDUSTRIAL APPLICABILITY

According to the parent-child card authentication system of the present application, it becomes possible to know the personal relationship between the parent card holder and the child card holder, and to manage the life cycle of IC cards having the parent-child relationship. Consequently, it becomes possible to easily grant the authority indicated by the parent card to the child card, thereby providing benefit to industry. Further, if the child card is disabled, the parent card is disabled. Therefore, the state information of life cycle of child card may influence the state information of life cycle of parent card.

1. A parent-child card authentication system, in which a first-generation card as an ancestor card authenticated by a root certificate authority, and a descendent card successively inheriting the authentication is generated, comprising:
a root certificate authority;
an Nth-generation card; and
an N+1th-generation card, wherein
said root certificate authority comprises
a generator for existence-proof information for first-generation card, which generates existence-proof information for first-generation card, which is for proving the existence of said first-generation card, in which the existence-proof information for the first-generation card is existence-proof information for card, which includes information regarding authentication capability, which indicates whether the first-generation card is capable of operating as a certificate authority, and proves the existence of a specific card authenticated by the system, and
a storage for confirmation information regarding existence-proof information for first-generation card, which stores confirmation information regarding existence-proof information for first-generation card, which is for confirming the authenticity of said existence-proof information for first-generation card, in which the confirmation information regarding existence-proof information for first-generation card is confirmation information for confirming an authenticity of existence-proof information for card, and
said Nth-generation card comprises
a storage for existence-proof information for Nth-generation card, which stores existence-proof information for Nth-generation card, which includes information regarding authentication capability, which indicates whether the Nth-generation card is capable of operating as a certificate authority, and can be authenticated based on the confirmation information regarding existence-proof information for first-generation card in said root certificate authority, and
a generator for existence-proof information for N+1th-generation card, which generates existence-proof information for N+1th-generation card, which can be authenticated based on the confirmation information regarding existence-proof information for first-generation card in said root certificate authority, based on said information regarding authentication capability, and
said N+1th-generation card comprises
a storage for existence-proof information for N+1th-generation card, which stores said existence-proof information for N+1th-generation card, and
a storage for identity-proof information for N+1th-generation card, which can store identity-proof information for N+1th-generation card in a secret state, in which the identity-proof information for N+1th-generation card is for proving that the card, of which existence is specified by said existence-proof information for N+1th-generation card, is the N+1th-generation card.

2. The parent-child card authentication system according to claim 1, wherein
said existence-proof information for N+1th-generation card includes self-identification information for uniquely identifying the N+1th-generation card.

3. The parent-child card authentication system according to claim 1, wherein
said existence-proof information for N+1th-generation card includes parent-identification information for uniquely identifying the Nth-generation card.

4. The parent-child card authentication system according to claim 1, wherein
said existence-proof information for N+1th-generation card includes information for specifying the ancestor card of the N+1th-generation card.

5. The parent-child card authentication system according to claim 1, wherein
said N+1th-generation card comprises
a generator for identity-proof information for N+1th-generation card, which generates identity-proof information for N+1th-generation card.

6. The parent-child card authentication system according to claim 1, wherein
said N+1th-generation card comprises
a storage for confirmation information regarding existence-proof information for N+2th-generation card, which stores confirmation information regarding existence-proof information for N+2th-generation card, which has one-to-one correspondence with the identity-proof information for N+1th-generation card stored by said storage for identity-proof information for N+1th-generation card,
an output unit for confirmation information regarding existence-proof information for N+2th-generation card, which outputs the confirmation information regarding existence-proof information for N+2th-generation card stored by said storage for confirmation information regarding existence-proof information for N+2th-generation card to the Nth card, and
an acquirer for existence-proof information for N+1th-generation card, which acquires the existence-proof information for N+1th-generation card outputted by said Nth-generation card, and
said Nth-generation card comprises
an acquirer for confirmation information regarding existence-proof information for N+2th-generation card, which acquires the confirmation information regarding existence-proof information for N+2th-generation card outputted by said output unit for confirmation information regarding existence-proof information for N+2th-generation card of said N+1th-generation card, and
an output unit for existence-proof information for N+1th-generation card, which outputs the existence-proof information for N+1th-generation card generated by said generator for existence-proof information for N+1th-generation card, wherein
said generator for existence-proof information for N+1th-generation card of said Nth-generation card generates said existence-proof information for N+1th-generation based on the confirmation information regarding existence-proof information for N+2th-generation card acquired by said acquirer for confirmation information regarding existence-proof information for N+2th-generation card.

7. The parent-child card authentication system according to claim 1, wherein
said existence-proof information for first-generation card generated by said generator for existence-proof information for first-generation card is information signed by means of a root secret key pair with a root public key used in public key encryption used for communication by said root certificate authority,
said confirmation information regarding existence-proof information for N+1th-generation card stored by said storage for confirmation information regarding existence-proof information for N+1th-generation card is said root public key, and
said identity-proof information for N+1th-generation card stored by said storage for identity-proof information for N+1th-generation card is a secret key of N+1th-generation card.

8. An Nth-generation card, which inherits an authentication of a first-generation card as an ancestor card authenticated by a root certificate authority, comprising:
a storage for existence-proof information for Nth-generation card, which stores existence-proof information for Nth-generation card, which includes information regarding authentication capability, which indicates whether the Nth-generation card is capable of operating as a certificate authority, and proves the existence of a specific card authenticated based on the authentication of the root certificate authority, and can be authenticated based on the confirmation information regarding existence-proof information for first-generation card in said root certificate authority;
a storage for identity-proof information for Nth-generation card, which stores identity-proof information for Nth-generation card, in which the identity-proof information for Nth-generation card is for proofing that the card, of which existence is specified by said existence-proof information for Nth-generation card, is the N+1th-generation card; and
a generator for existence-proof information for N+1th-generation card, which gives signature in accordance with the identity-proof information for Nth-generation card stored by said storage for identity-proof information for Nth-generation card, and generates existence-proof information for N+1th-generation card based on said information regarding authentication capability.

9. A card mediation apparatus, which mediates authentication of an N+1th-generation card by an Nth-generation card, in order to generate a descendent card successively inheriting the authentication from a first-generation card as an ancestor card authenticated by a root certificate authority, comprising:
an acquirer for confirmation information regarding existence-proof information for N+2th-generation card, which acquires confirmation information regarding existence-proof information for N+2th-generation card, which has one-to-one correspondence with the identity-proof information for N+1th-generation card of said N+1th-generation card, from said N+1th-generation card;
an output unit for confirmation information regarding existence-proof information for N+2th-generation card, which outputs the confirmation information regarding existence-proof information for N+2th-generation card acquired by said acquirer for confirmation information regarding existence-proof information for N+2th-generation card to said Nth-generation card;
an acquirer for existence-proof information for N+1th-generation card, which acquires existence-proof information for N+1th-generation card outputted by said Nth-generation card in accordance with the confirmation information regarding existence-proof information for N+1th-generation card outputted by said output unit for confirmation information regarding existence-proof information for N+2th-generation card; and
an output unit for existence-proof information for N+1th-generation card, which outputs the existence-proof information for N+1th-generation card acquired by said acquirer for existence-proof information for N+1th-generation card to said N+1th-generation card.

10. A parent-child card authentication method, in which a first-generation card as an ancestor card authenticated by a root certificate authority, and a descendent card successively inheriting the authentication is generated, comprising:
a generation step for existence-proof information for first-generation card, which generates existence-proof information for first-generation card, which is for proving the existence of said first-generation card, in which the existence-proof information for first-generation card is existence-proof information for card, which includes information regarding authentication capability, which indicates whether the first-generation card is capable of operating as a certificate authority, and proves the existence of a specific card authenticated by the system; and
a storing step for confirmation information regarding existence-proof information for first-generation card, which stores confirmation information regarding existence-proof information for first-generation card, which is for confirming an authenticity of said existence-proof information for first-generation card, in which the confirmation information regarding existence-proof information for first-generation card is confirmation information for confirming the authenticity of existence-proof information for card;
a storing step for existence-proof information for Nth-generation card, which stores existence-proof information for Nth-generation card, which includes information regarding authentication capability, which indicates whether the Nth-generation card is capable of operating as a certificate authority, and can be authenticated based on the confirmation information regarding existence-proof information for first-generation card in said root certificate authority,
a generation step for existence-proof information for N+1th-generation card, which generates existence-proof information for N+1th-generation card, which can be authenticated based on the confirmation information regarding existence-proof information for first-generation card in said root certificate authority, based on said information regarding authentication capability,
a storing step for existence-proof information for N+1th-generation card, which stores said existence-proof information for N+1th-generation card, and
a storing step for identity-proof information for N+1th-generation card, which can store identity-proof information for N+1th-generation card in secret state, in which the identity-proof information for N+1th-generation card is for proving that the card, of which existence is specified by said existence-proof information for N+1th-generation card, is the N+1th-generation card.

11. A parent-child utilization system, in which a descendent card successively inheriting an authentication of a first-generation card as an ancestor card is generated and is utilized, wherein
an Nth-generation card comprises
a storage for management information of card, which stores the management information of Nth-generation card including
identification information of parent card, which is for identifying N−1th-generation card as a parent card,
self-identification information, which is for identifying Nth-generation card as a child card, and
management information of life cycle of Nth-generation card, which is for managing state information of life cycle of Nth-generation card, which indicates life cycle of the Nth-generation card as the child card, based on the identification information of parent card.

12. The parent-child utilization system according to claim 11, wherein
the Nth-generation card comprises
an acquirer for management information of life cycle, which acquires management information of life cycle of N+1th-generation card, which is to be stored by the storage for management information of card in N+1th-generation card.

13. The parent-child utilization system according to claim 11, comprising:
a server for state information of life cycle, comprising,
an acquirer for management information of card, which acquires the management information of Nth-generation card from the Nth-generation card requesting an authentication,
a storage for state information of life cycle, which stores state information of life cycle correlated with identification information of card, in which the state information of life cycle indicates status of life cycle of a card identified by the identification information of card, and
a generator for state information of life cycle, which generates state information of life cycle of said Nth-generation card requesting the authentication, based on state information of life cycle of N-1th-generation card, which is acquired from said storage for state information of life cycle based on the identification information of parent card included in the management information of Nth-generation card acquired by said acquirer for management information of card, and on the management information of life cycle of Nth-generation card included in the management information of Nth-generation card acquired by said acquirer for management information of card.

14. The parent-child utilization system according to claim 13, wherein
said server for state information of life cycle comprises
a changer for state information of life cycle, which changes the state information of life cycle, which has been correlated with the identification information of said Nth-generation card, and stored by said storage for state information of life cycle, if the status of life cycle generated by said generator for state information of life cycle indicates that said Nth-generation card requesting the authentication is unusable.

15. The parent-child utilization system according to claim 13, wherein
said server for state information of life cycle comprises
an output unit for command to disable, which outputs a command, which disables said Nth-generation card, if the state information of life cycle of card generated by said generator for state information of life cycle indicates that said Nth-generation card requesting the authentication is unusable.

16. The parent-child utilization system according to claim 13, wherein
said server for state information of life cycle comprises
an output unit for request information for disabling, which outputs request information for disabling, which is for requesting other server to output a command, which disables said Nth-generation card, if the status of life cycle generated by said generator for state information of life cycle indicates that said Nth-generation card requesting the authentication is unusable.

17. A parent-child utilization method, in which a descendent card successively inheriting an authentication of a first-generation card as an ancestor card is generated and is utilized, wherein
a storing step for management information of card, which stores the management information of Nth-generation card in a readable state, in which the management information of Nth-generation card includes,
identification information of parent card, which is for identifying N−1th-generation card as a parent card,
self-identification information, which is for identifying Nth-generation card as a child card, and
management information of life cycle of Nth-generation card, which is for managing state information of life cycle of Nth-generation card, which indicates life cycle of the Nth-generation card as the child card, based on the identification information of parent card.

18. The management method for state information of life cycle, comprising,
an acquiring step for management information of card, which acquires the management information of Nth-generation card from the Nth-generation card requesting an authentication,
a storing step for state information of life cycle, which stores state information of life cycle correlated with identification information of card in a readable state, in which the state information of life cycle indicates status of life cycle of a card identified by the identification information of card, and
a generation step for state information of life cycle, which generates state information of life cycle of said Nth-generation card requesting the authentication, based on state information of life cycle of N-1th-generation card, which is acquired in said storing step for state information of life cycle based on the identification information of parent card included in the management information of Nth-generation card acquired by said acquiring step for management information of card, and on the management information of life cycle of Nth-generation card included in the management information of Nth-generation card acquired by said acquiring step for management information of card.
